(19) United States
(12) Patent Application Publication
(10) Pub. No.: US 2025/0181788 A1
(43) Pub. Date: Jun. 5, 2025

(54) METHODS AND SYSTEMS FOR DESIGNING RECONFIGURABLE KINEMATIC DEVICES

(71) Applicant: CARNEGIE MELLON UNIVERSITY, Pittsburgh, PA (US)

(72) Inventors: Humphrey Yang, Pittsburgh, PA (US); Mohammad F. Islam, Pittsburgh, PA (US); Carmel Majidi, Pittsburgh, PA (US); Lining Yao, Pittsburgh, PA (US); Dinesh K. Patel, Pittsburgh, PA (US); Tate Johnson, Pittsburgh, PA (US); Ke Zhong, Pittsburgh, PA (US); Gina Olson, Pittsburgh, PA (US)

(21) Appl. No.: 18/845,842

(22) PCT Filed: Mar. 13, 2023
(86) PCT No.: PCT/US2023/015125

§ 371 Date: Sep. 10, 2024

Related U.S. Application Data
(60) Provisional application No. 63/319,114, filed on Mar. 11, 2022.

(51) Int. Cl. G06F 30/17

(52) U.S. Cl. CPC G06F 30/17

(57) ABSTRACT

A method, system, and computer program product for designing reconfigurable kinematic devices. An example aspect is configured to: model two rigid stages of the device, assign at least one degree of freedom to at least one kinematic mode of the device; design at least one flexural rod; place at least one tunable flexure; assign a thickness to the at least one flexural rod; add mechanical details; and modularize the device for printing. A kinematic device configured to provide haptic feedback or motion control having at least two rigid stages, at least one kinematic mode, at least one flexural rod, and at least one tunable flexure.

### CROSS-REFERENCE TO RELATED APPLICATIONS

This application claims priority to and the benefit of U.S. Provisional Patent Application No. 63/319,114, filed on Mar. 11, 2022, entitled METHODS AND SYSTEMS FOR DESIGNING RECONFIGURABLE KINEMATIC DEVICES USING COMPLIANT MECHANISMS AND TENSION CABLES, which is expressly incorporated herein by reference in its entirety.

### STATEMENT REGARDING FEDERALLY FUNDED RESEARCH

This invention was made with United States government support under U.S. Pat. No. 2,047,912 awarded by the National Science Foundation. The U.S. government has certain rights in the invention.

### TECHNICAL FIELD

The present disclosure relates generally to the field of kinematic devices, and more particularly to methods for designing reconfigurable kinematic devices and devices designed by such methods.

### BACKGROUND

The human hand is a versatile instrument that affords the ability to interact with the environment tangibly and dynamically, and the resulting kinematic experiences make up an essential part of how we perceive the world around us. In the field of Human-Computer Interaction (HCI), there is an increased interest in creating devices that afford these kinematic interactions to support a more natural, intuitive, and enriched interaction experience.

However, designing multimodal and reconfigurable kinematic devices has been challenging. A mechanical joint such as a hinge or slider is needed for each targeted degree of freedom (DOF), and their integration may require expert knowledge and skills. The footprints of the mechanical components also impose a size limit, making it difficult to create miniaturized and compact interactive devices. Adding reconfigurability to the devices also requires latching or locking mechanisms, further exacerbating the design and fabrication complexity. As a result, existing interactive kinematic devices are often highly specialized and unimodal, possessing single kinematic modes and cannot adapt nor reconfigure to different use scenarios. Thus, it is desirable to create a method and system wherein users may design dynamically reconfigurable kinematic devices using compliant mechanisms wherein the devices are not subject to the constraints known in the art.

### SUMMARY

The present disclosure relates to methods and systems that allow users to design dynamically reconfigurable kinematic devices using compliant mechanisms (CMs) and tunable flexures, and to dynamically reconfigurable kinematic devices designed using the methods and systems disclosed herein. According to certain aspects, the methods and systems of the present disclosure include algorithms and computational tools that assist users in designing new dimensions of compliant mechanisms by introducing reconfigurability and multimodal kinematics.

The methods and systems of the present disclosure use a screw theory to calculate the flexural element layout and tunable flexure placements for the desired Degrees of Freedom (DOFs) and reconfigurations.

Accordingly, the present disclosure provides a method and system for designing reconfigurable kinematic devices that generally includes modeling two rigid stages, assigning Degrees of Freedom to each kinematic mode, designing flexural rods, placing tunable flexures, assigning a thickness to the flexural rods, adding mechanical details, and modularizing the model for printing.

According to certain aspects, the method and system may further comprise optionally adding stretchable sensors to enable desired functionalities resulting from user interaction. The stretchable sensors do not serve any structural functions, instead they allow the user to identify how the kinematic mechanism is being interacted with.

The methods and systems of the present disclosure generally enable users to design dynamically reconfigurable kinematic devices for human-computer interactions. Accordingly, the present disclosure also relates to dynamically reconfigurable kinematic devices designed using the methods and systems disclosure herein.

The presently disclosed systems and methods may be embodied as a system, method, or computer program product embodied in any tangible medium of expression having computer useable program code embodied in the medium.

### BRIEF DESCRIPTION OF THE DRAWINGS

It is to be understood that both the foregoing summary and the foregoing drawings and detailed description may be exemplary and may not be restrictive of the aspects of the present disclosure as claimed. Certain details may be set forth in order to provide a better understanding of various features, aspects, and advantages of the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention.

The present disclosure may be better understood by reference to the accompanying drawing sheets, in which:

FIG. 1 is a flow chart of a method for designing reconfigurable kinematic devices, in accordance with certain aspects of the present disclosure.

FIG. 2A shows a rigid body's six motional degrees of freedom in a 3-Dimensional space according to the screw theory of motion.

FIG. 2B shows flexural rods as wrench screw vectors according to the screw theory of motion.

FIG. 2C demonstrates motions as twist screw vectors according to the screw theory of motion.

FIG. 3A shows how a flexural rod constrains DOFs by resisting compression and extension.

FIG. 3B details how a tensioning cable controls extension only when tightened.

FIG. 3C shows how an elastic sensing cable imposes no constraint on the kinematic device.

FIG. 3D shows how tensioning cables may be tightened or loosened to reconfigure the device's DOF.

FIG. 4A details the design goals of a novel multimodal input device designed using the systems and methods of the present disclosure.

FIG. 4B represents the resulting model designed using the systems and methods of the present disclosure.

FIG. 4C represents the assembled device after being designed and 3-Dimsensionally printed using the systems and methods of the present disclosure.

FIG. 5 demonstrates how a user of the systems and methods of the present disclosure imports the input model and begins the design task by adding kinematic modes and specifying the DOFs of each mode.

FIG. 6A details how the systems and methods of the present disclosure provide visual and textual prompts to inform the user of the motional freedom space of the model for each kinematic mode, including Mode 4 (FIG. 6A), Mode 5 (FIG. 6B), Mode 6 (FIG. 6C), and all modes (FIG. 6D).

FIG. 7 shows how the systems and methods of the present disclosure guide the user to add flexural rods that are shared by all kinematic modes.

FIG. 8 demonstrates how the systems and methods of the present disclosure prevent a user from adding a flexural rod in an invalid placement.

FIG. 9A shows how the systems and methods of the present disclosure instruct the user on where to place valid tensioning cables that reconfigure the kinematic device.

FIG. 9B is an example of tensioning cable group 1 added for the novel multimodal input device of FIG. 3.

FIG. 9C is an example of tensioning cable group 2 added for the novel multimodal input device of FIG. 3.

FIG. 9D is an example of tensioning cable group 3 added for the novel multimodal input device of FIG. 3.

FIG. 10 demonstrates how the systems and methods of the present disclosure allows a user to optionally add stretchable sensors to the kinematic device. The systems and methods of the present disclosure then determine whether the Degree of Constraint may be sensed as a result of the user placement of the stretchable sensors.

FIG. 11 demonstrates how a user finalizes the kinematic device by adding mechanical details and modularizing the model for printing.

FIG. 12A demonstrates the unit module design for a kinematic material display prior to inputting the design into the methods and systems of the present disclosure.

FIG. 12B demonstrates the DOFs of the kinematic material display before and after tensioning cable tightening.

FIGS. 12C and 12D demonstrate the kinematic material display conforming to a curved surface.

FIG. 13A shows the structure of a wearable haptic proxy designed from the methods and systems of the present disclosure.

FIG. 13B shows the kinematic modes controlled by a pair of motors of a wearable haptic proxy designed from the methods and systems of the present disclosure.

FIG. 14A shows the tensioning cable pair placement of a rotational joint wherein the cable must not be parallel to the rotational axis.

FIG. 14B shows that the coerced twin of a tensioning cable may be found by rotating the cable 180 degrees about the rotational axis.

FIG. 14C shows that the corresponding endpoints generated by the placement of the tensioning cables must land on a different rigid body, which leads to opposite loads when deformed.

FIG. 15 shows the freedom and constraint topology of a compliant mechanism.

FIG. 16 shows the computing of shared flexural rod constraint space and the constraint subspaces of flexural rods and tensioning cables, wherein the shared flexural rod placement is computed by intersecting the constraint spaces of all kinematic modes.

FIG. 17A shows the DOF design validation for test samples using the methods and systems of the present disclosure, wherein FIGS. 17B and 17C show the results for translational and rotational DOFs, respectively.

FIG. 18A shows an example input design, wherein FIG. 18B shows the results of the rotational DOF reconfiguration test.

FIG. 19A shows an example input design, wherein FIG. 19B shows the results of the translational DOF reconfiguration test.

FIG. 20 is an exemplary design of stiffness-changing rods of the present disclosure.

FIG. 21 is a wearable device with stiffness-changing rods created by the methods and systems of the present disclosure, wherein the wearable device is worn by a wearer.

FIG. 22 is a wearable device with stiffness-changing rods created by the methods and systems of the present disclosure.

FIG. 23 is a forearm joint device in a locked state (FIG. 23A) and unlocked state (FIG. 23B) created by the methods and system of the present disclosure.

FIG. 24 is a graph of Torque (Nm) vs Displacement (Degree) of the device of FIG. 23 evaluated through finite element analysis.

FIG. 25 is a wrist joint device created by the systems and methods of the present disclosure in states wherein both rotations are locked (FIG. 25A), flexion is unlocked (FIG. 25B), deviation is unlocked (FIG. 25C), and both flexion and deviation are unlocked (FIG. 25D).

FIG. 26A through FIG. 26D are graphic results of mechanical testing of the wrist joint device of FIG. 25, including the load displacement relationship along the flexion axis (FIG. 26A) and the load displacement relationship along the deviation axis (FIG. 26B), wherein the stiffness was calculated at design criteria along the flexion (FIG. 26C) and deviation (FIG. 26D) rotational degrees of freedom.

FIG. 27 is a finger joint device created by the systems and methods of the present disclosure, wherein all the joints are in a locked state.

FIG. 28A is the finger joint device of FIG. 27, wherein the proximal interphalangeal (PIP) joint is unlocked.

FIG. 28B is the finger joint device of FIG. 27, wherein the metacarpophalangeal (MP) joint is unlocked.

FIG. 28C is the finger joint device of FIG. 27, wherein the distal interphalangeal (DIP) joint is unlocked.

FIG. 28D is the finger joint device of FIG. 27, wherein the PIP, MP, and DIP joints are unlocked.

FIG. 29A is a performance analysis of the PIP joint of the finger joint device of FIG. 27 evaluated through finite element analysis.

FIG. 29B is a performance analysis of the MP joint of the finger joint device of FIG. 27 evaluated through finite element analysis.

FIG. 29C is a performance analysis of the DIP joint of the finger joint device of FIG. 27 evaluated through finite element analysis.

FIG. 30 is a haptic thimble device created by the systems and methods of the present disclosure, wherein the device is in an undeformed state.

FIG. 31 is the haptic thimble device of FIG. 30 in a stiff mode (FIG. 31A), partially softened mode (FIG. 31B), and a soft mode (FIG. 31C).

FIG. 32A is a graphic result of the load displacement of different modes (00000, 00001, 01001, 01101, 11101, 11111) of the haptic thimble device of FIG. 30.

FIG. 32B is the calculated stiffness of the haptic thimble device of FIG. 30 according to the hand-feel of a person touching a gelled solution of gelatin, PU foam, and rubber or metal while wearing the device of FIG. 30.

FIG. 33 is a device created by the systems and methods of the present disclosure, wherein the device may lock and unlock any of the six motional degrees of freedom in a 3-dimensional space.

FIG. 34 is the load-displacement relationship of the device of FIG. 33 along each of the degrees of freedom and the stiffness of the device of FIG. 33 calculated at 1% displacement with respect to the device's length in the locked and unlocked states.

FIG. 35A is a depiction of a user wearing the forearm joint device of FIG. 23, wherein the user is opening a locked and unlocked door in virtual reality.

FIG. 35B is a depiction of a user wearing the wrist joint device of FIG. 25, wherein the wrist joint device temporarily prevents flexion to possibly alleviate pain from carpal tunnel syndrome.

FIG. 35C is a depiction of a user wearing the finger joint device of FIG. 27, wherein the finger joint device allows a user to selectively enable motion at a joint for targeted muscle group training.

FIG. 36 is a depiction of a user using the haptic thimble device of FIG. 30 in an undeformed state.

FIG. 37 is a drawing of the aluminum casting jig of the present disclosure.

FIG. 38A is an illustration of the aluminum casting jig of the present disclosure before casting.

FIG. 38B is an illustration of the aluminum casting jig of the present disclosure wherein the silicone tubes are fixed and taped to the jig.

FIG. 38C is an illustration of the aluminum casting jig of the present disclosure wherein the heating wires are threaded and secured.

FIG. 38D is an illustration of the aluminum casting jig of the present disclosure wherein the epoxy is injected.

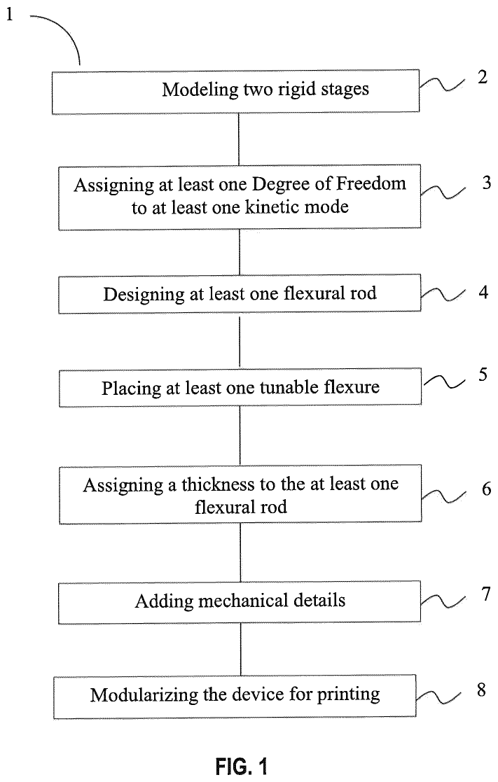

### DETAILED DESCRIPTION

The present disclosure generally describes systems and methods for designing multimodal and reconfigurable kinematic devices using compliant mechanisms and tunable flexures. The methods and systems of the present disclosure include algorithms and computational tools that enable users to design multimodal and reconfigurable kinematic devices.

The present disclosure also provides dynamically reconfigurable kinematic mechanisms or devices designed using the methods and systems disclosed herein. The dynamically reconfigurable kinematic mechanisms may include devices having compliant mechanisms and tensioning cables configured as specific human computer interfaces.

### Definitions

In this disclosure, certain terms are used which shall have the meanings set forth as follows.

As used herein, the term “user” may be used interchangeably and may be taken to include a person or entity using the methods and systems of the present disclosure.

Various aspects of the systems and methods may be described and illustrated with reference to one or more exemplary implementations. As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described event or circumstance may or may not occur, and that the description includes instances where the implementation occurs and instances where it does not.

Note that various terminology used herein may imply direct or indirect, full or partial, temporary or permanent, action or inaction. For example, when an element is referred to as being “on,” “connected,” or “coupled” to another element, then the element may be directly on, connected, or coupled to the other element or intervening elements may be present, including indirect or direct variants. In contrast, when an element is referred to as being “directly connected” or “directly coupled” to another element, there are no intervening elements present.

It must also be noted that as used herein and in the aspects, the singular forms “a”, “an”, and “the” include the plural reference unless the context clearly dictates otherwise. As example, “a” tensioning cable may comprise one or more tensioning cables, and the like.

As used herein, the term “and/or” includes any and all combinations of one or more of the associated listed items. Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

As used herein, the term “compliant mechanism” refers to those mechanisms that achieve the transfer or transformation of motion, force, or energy via the elastic bending of their flexible members. A compliant mechanism comprises slender flexural elements connecting between rigid bodies, and its degrees of freedom are determined by the flexures' positions and directions.

As used herein, the term “flexures” refers to motion control elements that provide precise motion control without friction or wear. The term “tunable flexures” refers to motion control elements capable of being tuned to adapt to robust interactions with an environment. A tunable flexure may be designed to be compliant in its degree(s) of freedom but also a level of stiff in its degree(s) of constraint. A “tunable flexure” includes, but is not limited to, a tensioning cable, wherein the tensioning cable may be tightened or loosened to allow for reconfiguration of a device of a joint within a device. A “tunable flexure” also includes, but is not limited to, a stiffness-changing rod, wherein the stiffness-changing rod may be hardened or softened to allow reconfiguration of a device or a joint with a device.

As used herein, the term “degrees of freedom” (DOFs) refers to the number of independent movements in which a mechanical device or mechanism may move in space. A mechanical device or mechanism is considered to have a kinematic degree of freedom when it is free to translate along or rotate about an axis.

As used herein, the term “degrees of constraint” (DOCs) refers to the kinematic constraints between rigid bodies that result in a decrease of the degrees of freedom of a mechanical device or mechanism. A mechanical device or mechanism is considered to have a degree of constraint when it is unable to generate motion along or about an axis.

Various aspects of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, direct-access storage devices, tapes, CDs, DVDs, thumb drives, and other memory media, etc.) may be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present disclosure may be embodied in a system, a method, and/or a computer program product. Accordingly, the term “system” may be understood to include an implementation of the presently disclosed methods that is executable on a processor, such as processor-executable instructions that may be stored on a non-transitory memory (e.g., computer program product). As used herein, the terms system and method may be used interchangeably and reference to one should be understood to include reference to both unless specifically indicated otherwise.

Accordingly, the presently disclosed invention may take the form of an entirely hardware embodiment, an entirely software embodiment (including firmware, resident software, micro-code, etc.), or an embodiment combining software and hardware aspects that may all generally be referred to herein as a “system”. Furthermore, the presently disclosed invention may take the form of a computer program product embodied in any tangible medium of expression having computer useable program code embodied in the medium.

The computer program product may include a computer readable storage medium (or media) having computer readable program instructions thereon for causing a processor to carry out aspects of the present disclosure. The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. Note that the computer-useable or computer-readable medium may be paper or another suitable medium upon which the program is printed, as the program may be electronically captured, via, for instance, optical scanning of the paper or other medium, then compiled, interpreted, or otherwise processed in a suitable manner, if necessary, and then stored in a computer memory. In the context of this document, a computer-useable or computer-readable medium may be any medium that may contain, store, communicate, propagate, or transport the program for use by or in connection with the instruction execution system, apparatus, or device. The computer-useable program code may be transmitted using any appropriate medium, including but not limited to wireless, wireline, optical fiber cable, RF, etc.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages.

Computer program code for carrying out operations of the presently disclosed invention may be written in any combination of one or more programming languages. The programming language may be, but is not limited to, object-oriented programming languages (Java, Smalltalk, C++, etc.) or conventional procedural programming languages (“C” programming language, etc.). The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The systems and methods of the present disclosure may process data on any commercially available computer. In other aspects, a computer operating system may include, but is not limited to, Linux, Windows, UNIX, Android, or MAC OS. In one aspect of the present disclosure, the forgoing processing devices or any other electronic, computation platform of a type designed for electronic processing of digital data as herein disclosed may be used.

Aspects of the present disclosure are described with reference to flowchart illustrations and/or block diagrams of methods, systems, and computer program products according to aspects of the present disclosure. It will be understood that each block of the flowchart illustrations and/or block diagrams, and combination of blocks in the flowchart illustrations and/or block diagrams, may be implemented by computer program instructions. These computer program instructions may be provided to a processor of a general purpose computer, special purpose computer, or other programmable data processing apparatus to produce a machine, which the instructions execute via the processor of the computer or other programmable data processing apparatus allowing for the implementation of the steps specified in the flowchart and/or block diagram blocks or blocks. code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others.

A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others.

Words such as “then,” “next,” etc. are not intended to limit the order of the steps; these words are simply used to guide the reader through the description of the methods.

In the following description, certain details are set forth in order to provide a better understanding of various aspects of the methods disclosed herein. However, one skilled in the art will understand that these aspects may be practiced without these details and/or in the absence of any details not described herein. In other instances, well-known structures, methods, and/or techniques associated with methods of practicing the various embodiments may not be shown or described in detail to avoid unnecessarily obscuring descriptions of other details of the various aspects.

Unless defined otherwise, all technical and scientific terms used herein have the same meanings as commonly understood by one of ordinary skill in the art.

### Aspects of the Present Disclosure

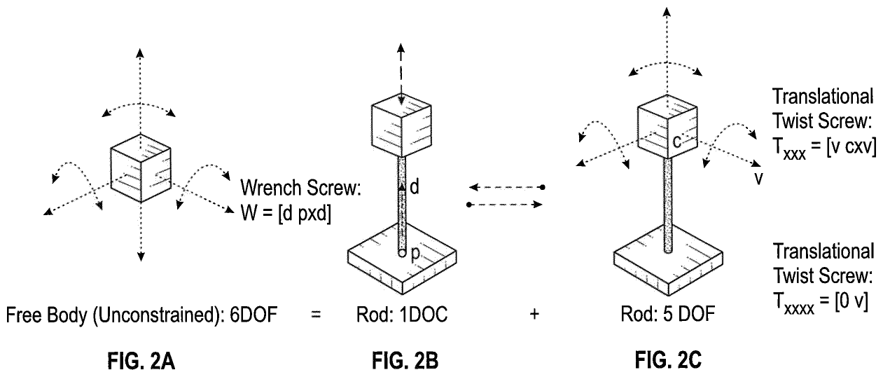

The methods 1 of the present disclosure utilize screw theory to design multimodal and reconfigurable kinematic devices using compliant mechanisms and tensioning cables. The screw theory is a geometric formulation of motional DOFs, in which a DOF is represented by a six-dimensional screw vector that encodes the direction and position of the translational/rotational axis (see FIG. 2A). The configuration of a rigid body in 3-Dimensional space is defined by six numbers, which are defined by their position and rotation along the three principal axes shown in FIG. 2A.

A screw vector T is defined as T=[v c×v+n·v], wherein v and c are 3-Dimensional vectors that represent the direction of the axis and a point on that axis, respectively, and n is scalar that represents the ratio between translation and rotation of the screw motion (FIG. 2C). These vectors may be linearly combined into a new motion. For pure rotations, n=0 and vis a non-zero vector. For pure translations, it is assumed to have an infinite ratio between translation and rotation, and the vector has a normalized form of [T]=[0 v].

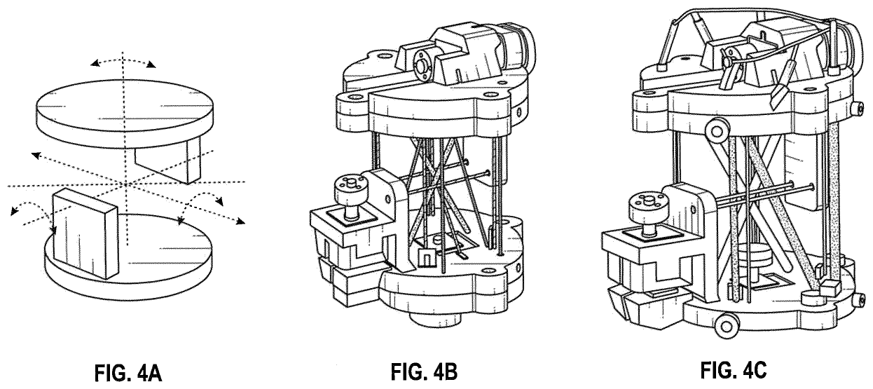

Accordingly, a method 1 of the present disclosure allows a user to import an input model detailing design goals for a kinematic device (FIG. 4A). The method may then model the two rigid stages 2, dependent on the design of the input model. As used herein, the term “rigid stage” is a part in a device with a comparatively bulky aspect ratio. The rigid stages may comprise one fixed end and one free end.

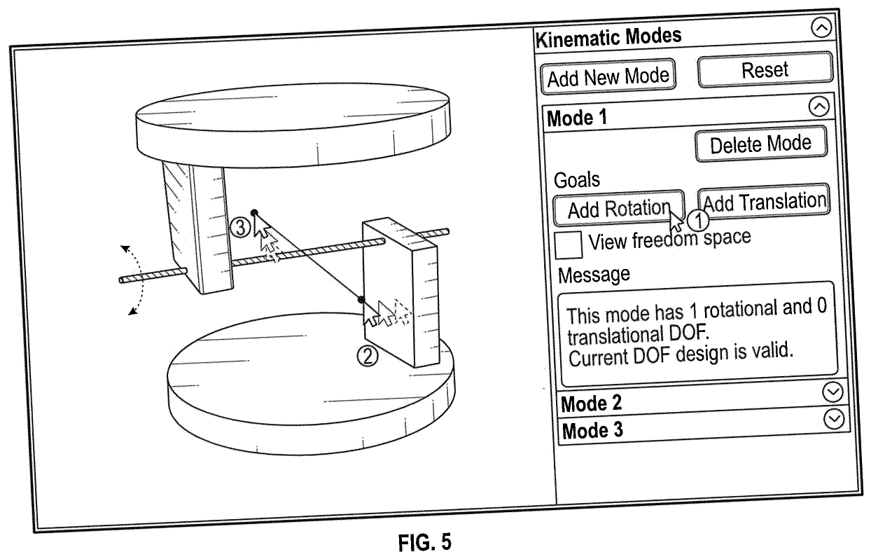

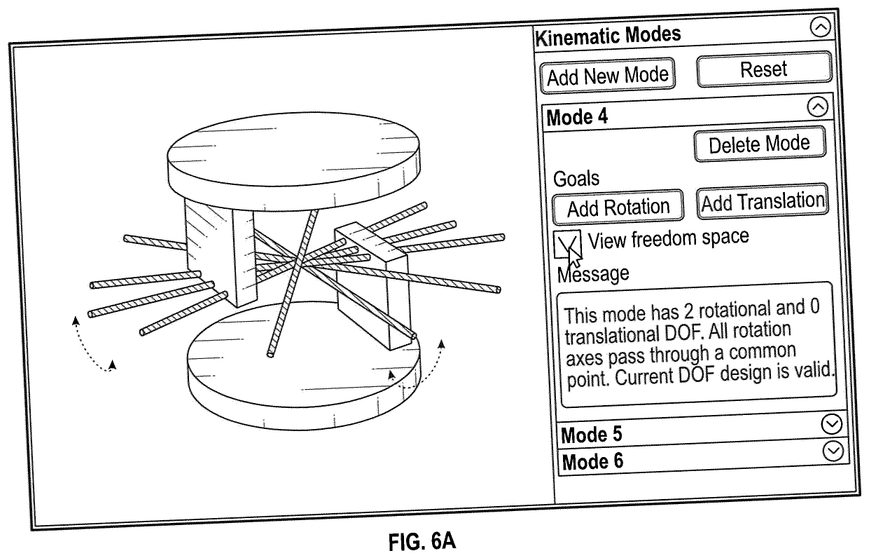

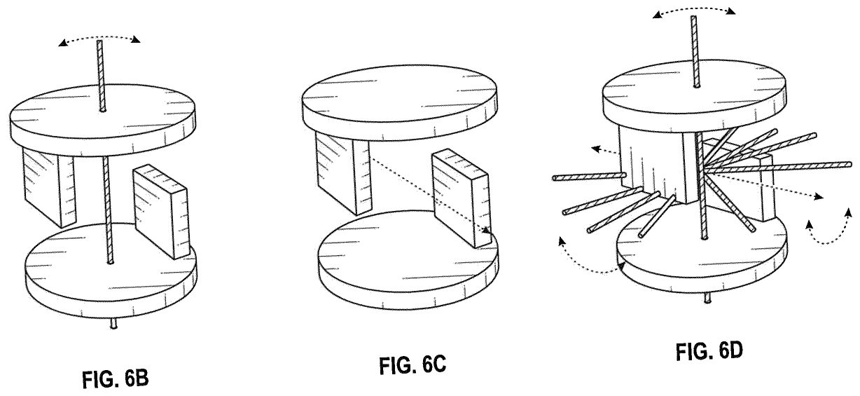

After importing the input model, a user is prompted to add kinematic modes and specify the DOFs of each mode 3 (FIG. 5), wherein the method 1 may assign at least one DOF to at least one kinetic mode 3. To represent the DOFs, the user is prompted to add several possible rotation axes, which visualizes the freedom space for the user (FIG. 6A).

Once the DOFs are assigned, the method may provide visual and textual prompts to inform the user of the motional freedom space (FIG. 6A), and the DOF goals are added for each kinematic mode added by the user (FIG. 6B).

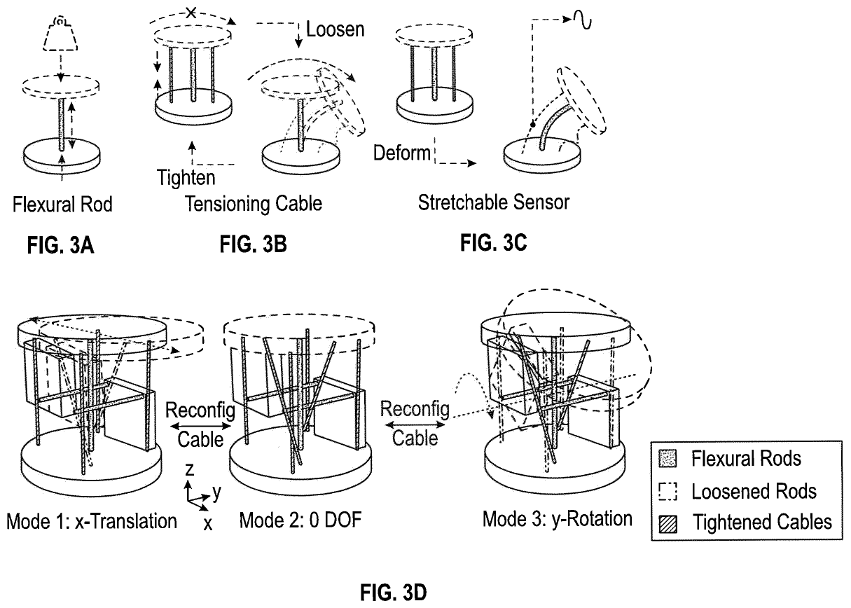

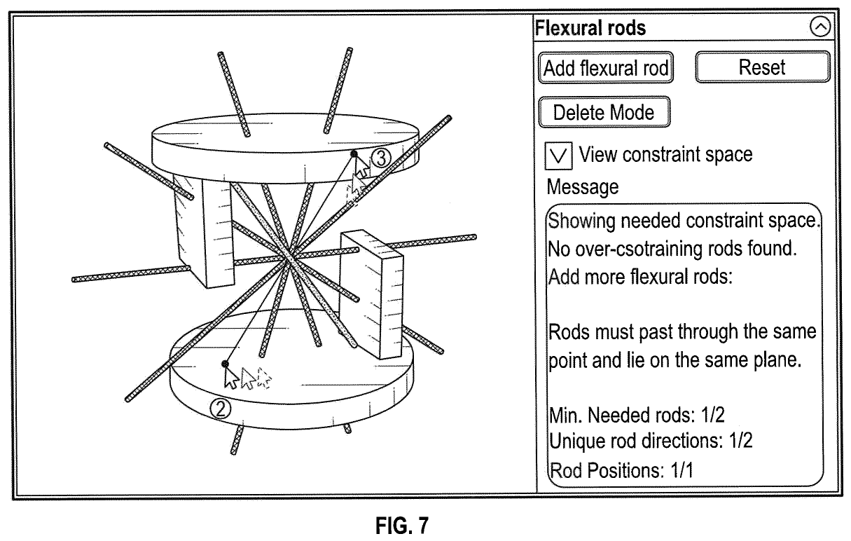

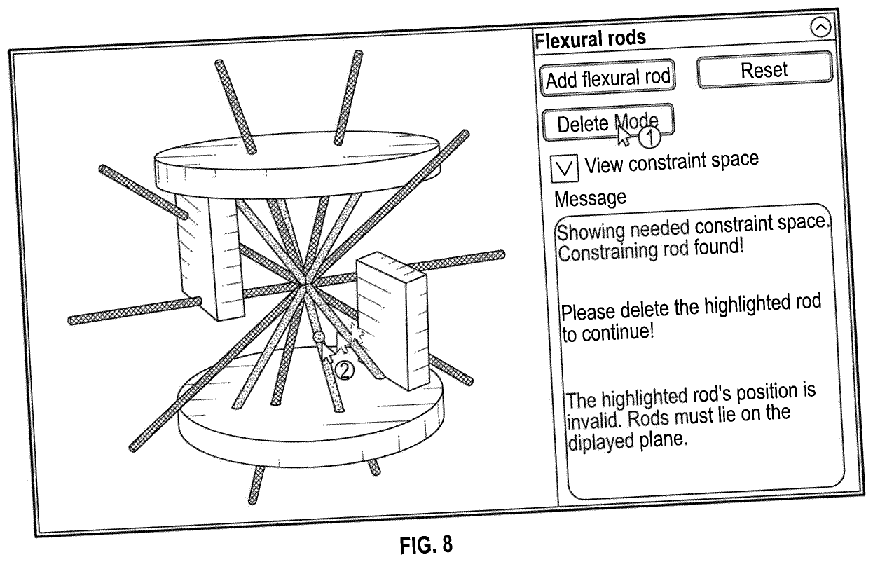

Next, the method guides the user through designing at least one flexural rod 4. The flexural rods are shared by all kinematic modes and are not reconfigurable. Flexural rods constrain DOFs by resisting compression and extension (FIG. 3A). The constraint space visualization of the method of the present disclosure suggests the location and orientation of permitted flexural rod placements (FIG. 7). The method may include textual descriptions to place the flexural rods iteratively until the constraint spaces are satisfied and complete (FIG. 7). If the user places a flexural rod in an invalid position or orientation that causes the compliant mechanism to be over- and ill-constrained, the method may highlight the invalid placement and prompt the user to correct it (FIG. 8). A flexural rod of the present disclosure may have a slenderness of about 1:10 to 1:20.

The method of the present disclosure models the flexural rods and their corresponding Degrees of Constraint using the screw theory. The constraining screw or wrench vector (W) of the flexural rods is represented as W=[d p×d], wherein d is the longitudinal axis of the flexural rod and p is a point on the flexural rod. The constraining screws may be linearly combined to form constraint spaces [w]. Since DOFs and DOCs are complimentary, when one is known, the other may be solved using the equation [W]Δ[T]^{T}=[0], wherein [W] and [T] are the method's constraint and freedom spaces, respectively. Δ is a swap operator defined in Frederick Sun, et al. (2017), and [0] is a 66 zero matrix.

The constraint and freedom space of each kinematic mode may be calculated based on the motion axis specified by the user in the first step of the methods of the present disclosure. The line itself creates a directional vector, and either of the endpoints may be used as a reference point on the axis. T=[v c×v+n·v] may be used to determine a twist vector of the desired motion. It is important to simplify the freedom space prior to computing the complimentary constraint space since the motions assigned under a kinematic mode may contain linear redundancies that may complicate the calculation.

Given a matrix [Tᵢ′] that collects all twist vectors under a kinematic mode i, its non-redundant freedom space [Tᵢ] may be found by finding the kernel of its nullspace. The outcome [Tᵢ] may then be used with [W]Δ[T]^{T}=[0] to compute the kinematic mode's constraint space [Wᵢ].

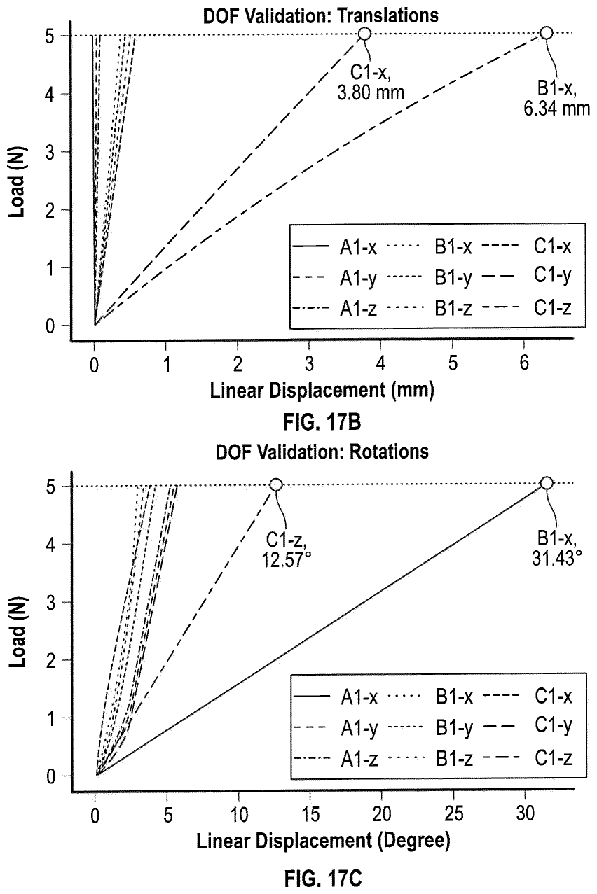

Given a collection of constraint spaces associated with each kinematic mode, shared flexural rod placements [Wshared] may be identified by finding their intersection or wrench vectors shared by all modal constraint spaces (FIG. 17A). Given a matrix [Tₐₗₗ] that contains all twist vectors under all kinematic modes, the intersection may be found by finding the nullspace of [Tₐₗₗ].

If the current design's axial or positional component's rank is higher than that of the target, the device is considered over-constraining, and the methods of the present disclosure may prompt the user to reduce the degree of constraints by removing the respective flexural rod elements. Over-constraining flexural rods may be identified by checking whether they are linearly spanned by the target constraint space. If the current design's rank is lower than that of the target, then the kinematic device is under-constrained, and the methods of the present disclosure may prompt the user to add more flexural rods.

The textual prompts of the methods may guide a user to design flexural rod placements that satisfy and complete the freedom and constraint spaces. This is done by comparing the current design with the targeted constraint spaces. The direction and positional components of the constraint space may be evaluated individually, and each is considered complete when the current design's respective screw vector parts have the same rank as the targeted constraint space. The minimally needed and existing number of unique flexural rods may be calculated as the rank of the non-redundant constraint space.

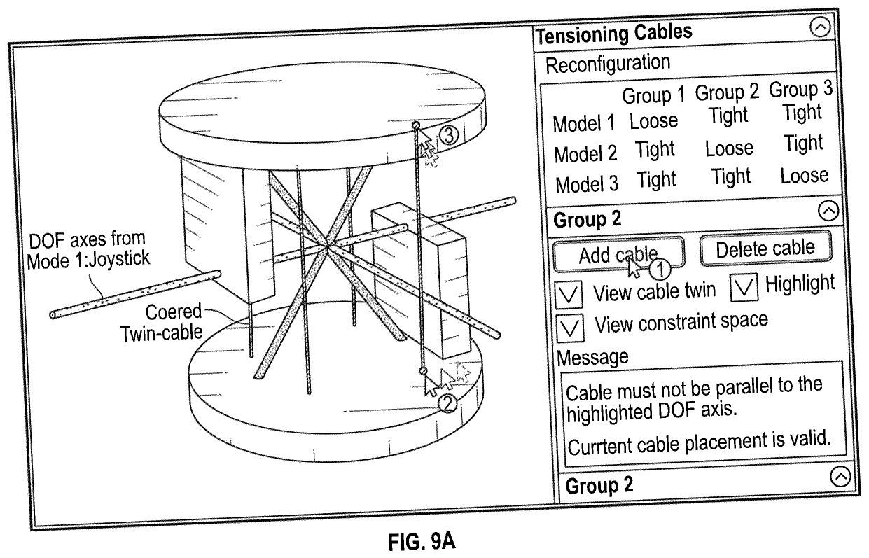

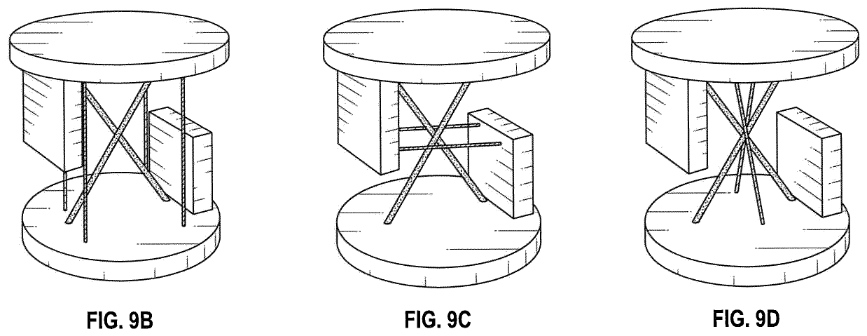

Following the placement of the flexural rods, the methods may guide the user to place at least one tunable flexure 5 that reconfigures the kinematic device. The at least one tunable flexure may be a tensioning cable (FIG. 9A). Tensioning cables control extension only when tightened (FIG. 3B). Tensioning cables may be tightened or loosened to reconfigure at least one degree of freedom of the device (FIG. 3D). When loosened, the tensioning cable may not provide constraint, and the tensioning cable may allow at least one degree of freedom that was previously disabled prior to the tensioning cable being loosened. At least one tensioning cable may also be tightened to reconfigure at least one degree of freedom of the device, wherein the at least one tensioning cable constrains extension. Unlike the flexural rod placements, the user has more freedom to determine where to place the tensioning cables as long as the directions of the cables follow the design rules from the input model. The tensioning cables may be assigned into groups that are actuated together, which produces a reconfiguration plan for the kinematic modes. If the tensioning cables must be added in pairs to balance their loads, the methods may generate a coerced twin-cable whenever the user places one tensioning cable (FIG. 9B). The method may then notify the user of an invalid tensioning cable placement and prompt the user to correct it.

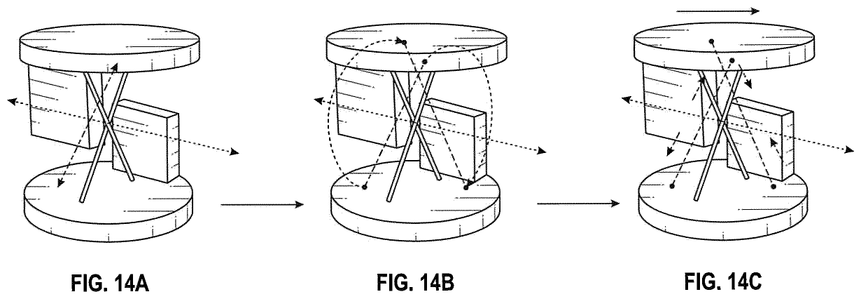

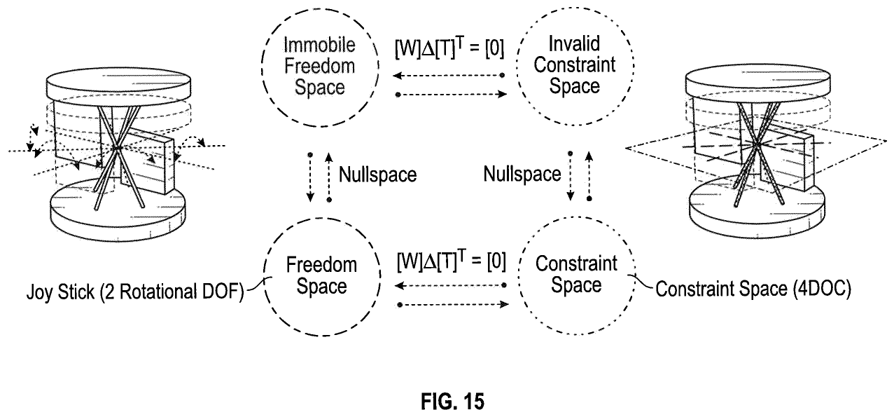

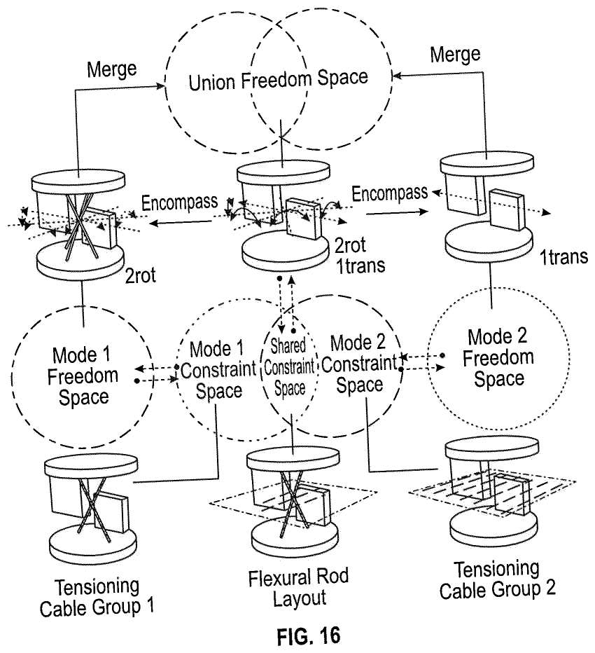

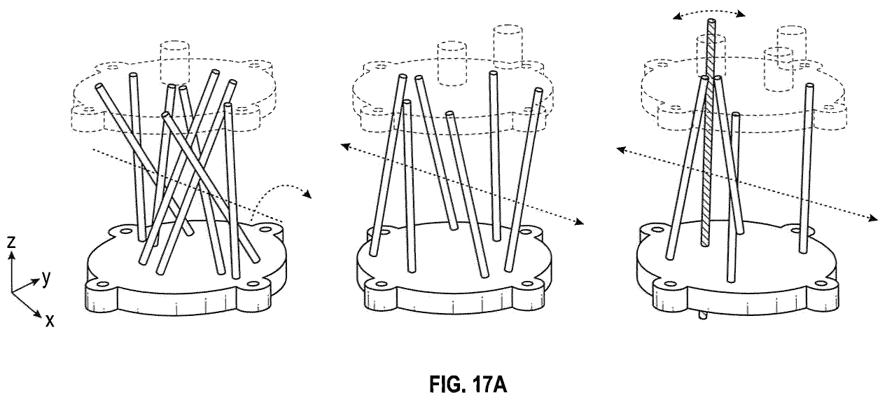

The tensioning wire placement [W_{cable}] for a kinematic mode [Wᵢ] may be calculated by the difference between the modal constraint space [Wᵢ] and the shared flexures [W_{shared}] (FIG. 16). This may be calculated by finding the kernel of the concatenation of [W_{shared}] and [Wᵢ]'s nullspace. Some combinations of [W_{shared}] and [Wᵢ] may lead to a [W_{cable}] with all-zero directional components, which, geometrically speaking, results in invalid rod placements (i.e., axis-less rods). If this occurs, the method may use the directional components from [W_{shared}] and/or [Wᵢ] to generate a valid constraint space. A cable's coerced twin in the pair may be found by rotating its wrench vector 180 degrees around the motional axis they are constraining (FIGS. 14A, 14B). For translational constraint cables, their directions must not be perpendicular to the translational axis, whereas, for rotational constraints, the cables must not be parallel to the rotational axis nor pass through the rotational axis. Additionally, after rotation, the corresponding endpoints in the cable pairs must land on different rigid bodies, to ensure the cables would experience opposite axial forces under external loads (FIG. 14C).

The at least one tunable flexure may comprise a stiffness-changing rod, wherein the stiffness-changing rod comprises stiffness-changing materials. Stiffness-changing rods permit designs wherein motors or tensioning cables may not be ideal, such as wearable devices with lightweight and resilience characteristics.

The stiffness-changing rods may be made of epoxy resin having a glass transition temperature (T_{g}) of around 50° C. The stiffness-changing rod of the present disclosure may function as a wire flexure in compliant mechanism designs, wherein the stiffness-changing rods may bend to allow any motion except for axial extension or compression. When heated above the transition temperature (T_{g}), the resin's elastic modulus may drop by 2 to 3 orders of magnitude, and the stiffness-changing rods will become mobile in the axial direction.

Thus, stiffness-changing rods of the present disclosure may resist or allow axial deformation dependent upon their configured state, such as whether the stiffness-changing rods are heated or cooled. To control temperature, the stiffness-changing rods of the present disclosure may comprise a metallic resistive heating wire at the center of the rods. The heating wires may be subjected to a small, if any, strain due to being place at the neutral axis of the stiffness-changing rods. However, the placement of the heating wires in the center is less likely to interfere with deformation and cause damage to the structure.

Unlike tensioning cables, stiffness-changing rods may be vulnerable to tensile loads due to the resin and heating wire making the stiffness-changing rods prone to fracture against tensile strain. Thus, the stiffness-changing rods may be susceptible to failure when subjected to extension, where the strain within the elements exceeds the maximum strength allowable. When subjected to a compressive load, the stiffness-changing rods may buckle and bend to conform to the deformation, which may cause smaller strains within the resin and heating wire. Thus, the method may accommodate the deformation modes of the stiffness-changing rods by ensuring all stiffness-changing rods are subjected to compression in every kinematic mode that it is designed for.

Unlike tensioning cable and motor systems, stiffness-changing rods are not required to be placed in pairs.

To accommodate that only compressions are allowed for stiffness-changing rods, the method 1 may determine whether a stiffness-changing rod is subjected to extension or compression under any kinematic mode. D=(\hat{n}ₐₓᵢₛ×(\hat{r}_{rod}−ĉₐₓᵢₛ))·\hat{n}_{rod} may be used for rotational motions and D=\hat{n}ₐₓᵢₛ·\hat{n}_{rod} may be used for translational motions, wherein D is a scalar indicating a stiffness-changing rod's direction with respect to the motion, \hat{n}ₐₓᵢₛ and \hat{n}_{rod} are vectors along the motional and rod axis, respectively, and ĉₐₓᵢₛ and \hat{r}_{rod} are reference points on the motional and rod axis, respectively. \hat{n}_{rod} points from the stiffness-changing rod's fixed end to the mobile end. The stiffness-changing rod may be subjected to compression if D is less than 0 and extension if D is greater than 0. If D=0, the stiffness-changing rod is subjected to bending and may not be susceptible to failure against the motion.

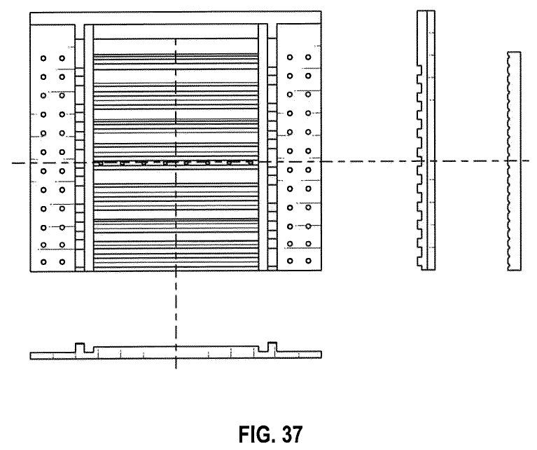

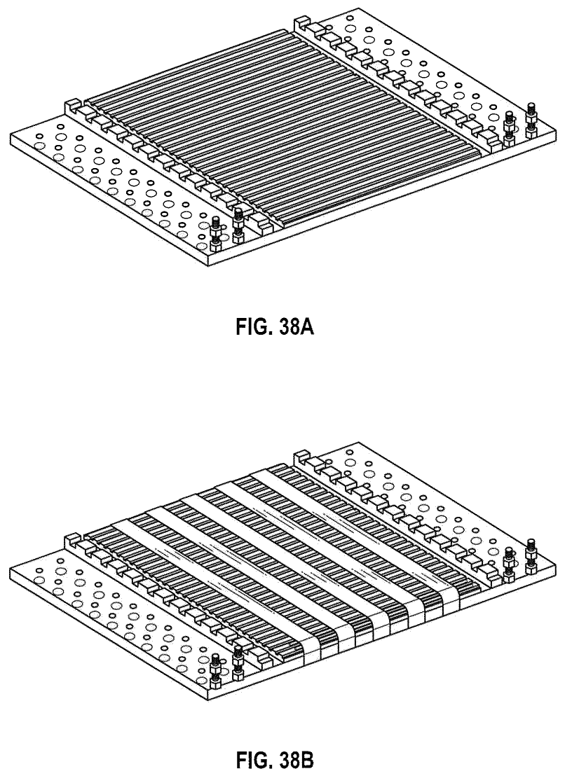

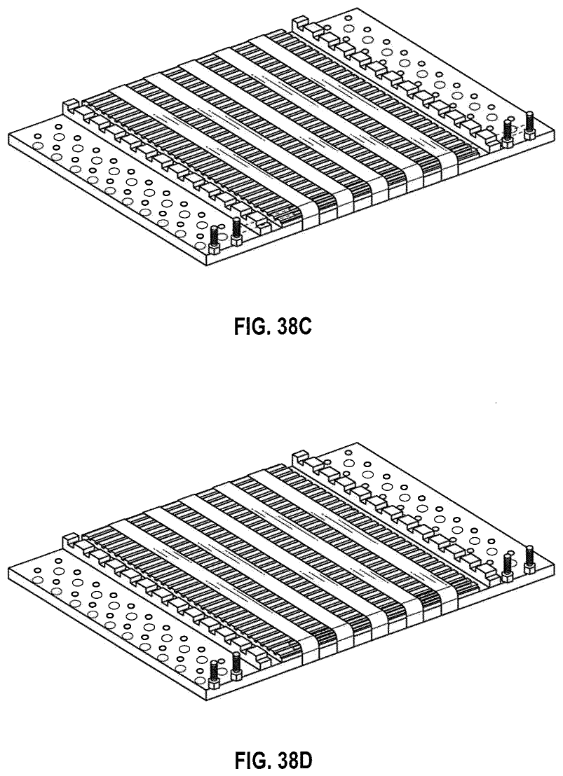

The stiffness-changing rods of the present disclosure may be prepared using a casting technique in customized jigs as shown in FIG. 37. The customized jig of the present disclosure may be machined from a metal, such as 6061 aluminum stock (McMaster-Carr). The customized jig may have hemicylindrical grooves, alignment features, and securing screws and nuts for lining up heating wires at the center of the rods (FIG. 38A). To cast the rods, silicone tubes, such as silicone tubes with 2 mm inner diameter (ID) by 3 mm outer diameter (OD) or 1.5 mm ID by 3 mm OD may be utilized. The silicone tubes may be cut to the desired length, placed on the grooves, and taped to the jig to allow for threading heating wires through their center (FIG. 38B). The alignment features on both ends of the grooves may ensure the heating wires are positioned at the center of the silicone tubes (FIG. 38C). After the heating wires are tightened and straightened, the screws and nuts on the far ends may be used to secure the heating wires in place.

The casting solution may comprise an epoxy resin such as polymerized Hexion EPON resin 828, and a cross linker such as Epikure 3380 combined at a weight ratio of 10:4, respectively. The solution may then be mixed and degassed for three minutes each using a planetary centrifugal mixer to ensure a uniform solution. The mixed resin may then be injected into the silicone tubes on the aluminum jig (FIG. 38D). After placed in the cast, the resin may rest at 25° C. for at least twenty-four hours followed by thermal curing at 100° C. in a convection oven for five hours to ensure complete crosslinking. The cured resin rods and the jig may then be removed from the oven and cooled to 25° C. The stiffness-changing rods sheathed in the silicone tubes may then be released from the jig by removing the tape and loosening the nuts securing the heating wires. The stiffness-changing rods may then be unsheathed by slicing and peeling off the silicone tubes.

The rigid stages of a device having stiffness-changing rods may be printed and designed with circular cavities for housing the stiffness-changing rods. The stiffness-changing rods may be inserted into the cavities wherein an adhesive such as cyanoacrylate (Scotch-Weld, 3M) may be applied at an interface. The device having stiffness-changing materials may then be dried at 25° C. for twenty-four hours. The heating wires may then be connected to conductive wires (Continuous-Flex Wire 600V AC 26 gauge, McMaster-Carr) by ferrules (Copper rivets 0.4 mm, Voltera) approximately 3 mm away from the end of the stiffness-changing rods wherein the heating wires are exposed.

The stiffness-changing rods may be heated above its glass transition temperature by connecting the two ends of the conductive wires to a power supply and provide approximately 5.88*10⁻³ watts/mm to the heating wire (rated resistance: 3.68*10⁻² Ω/mm). To cool the stiffness-changing rods below its glass transition temperature, the current may be removed, and heat may be allowed to passively dissipate in ambient conditions of 25° C. without extraneous loads. External load may cause the stiffness-changing rod to retain its shape in a deformed state as it cools down, which may alter a device's kinematic freedoms unintentionally. Multiple stiffness-changing rods may be heated at the same time by serially connecting the heating wires in an end-to-end fashion. Relays and/or transistors may be utilized to allow for digital control and reconfiguration of a device.

The systems and methods of the present disclosure provide a device comprising a stiffness-changing rod wherein the stiffness-changing rod may be heated and/or cooled using at least one relay and/or at least one transistor. Thus, the systems and methods of the present disclosure may provide digital control and reconfiguration of devices of the present disclosure.

After placing the flexural rods, the user has the option to add stretchable sensors to convert the model into an input device. The method of the present disclosure may guide the user to place the sensors in appropriate orientations, wherein the stretchable sensors must follow the design rules from the input model. The method may also notify the user of an invalid stretchable sensor placement and prompt the user to correct it.

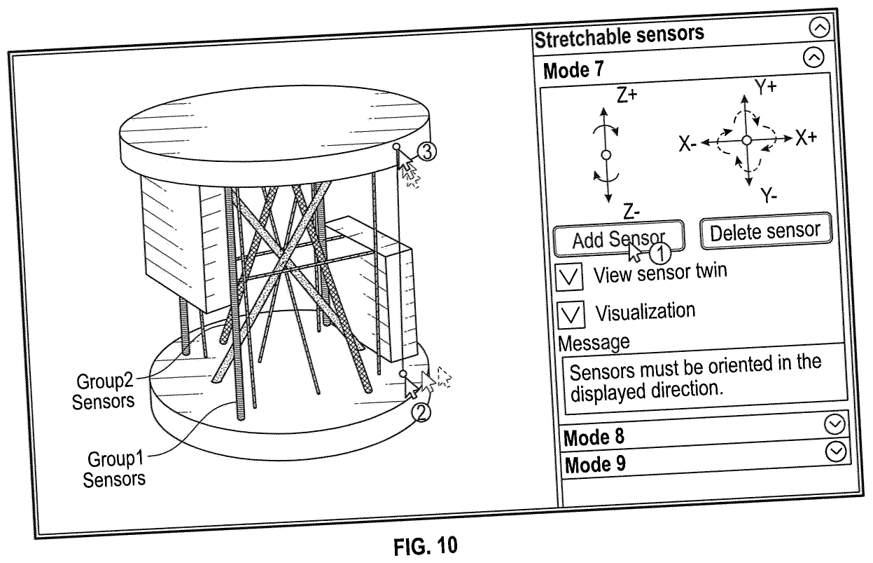

The method of the present disclosure may instruct the user on which stretchable sensors may be stretched along a particular DOF (FIG. 10). The method may inform the circuit logic and controller firmware design of the current sensor layout.

The stretchable sensors do not have any constraining effect due to their extensibility (FIG. 3). To determine whether a sensor is responsive to a DOF, the free end of the sensor cable is moved a finite amount along the motional direction. If the distance between the two ends increases after the finite amount, then the sensor will be stretched under the respective motion and produce a signal.

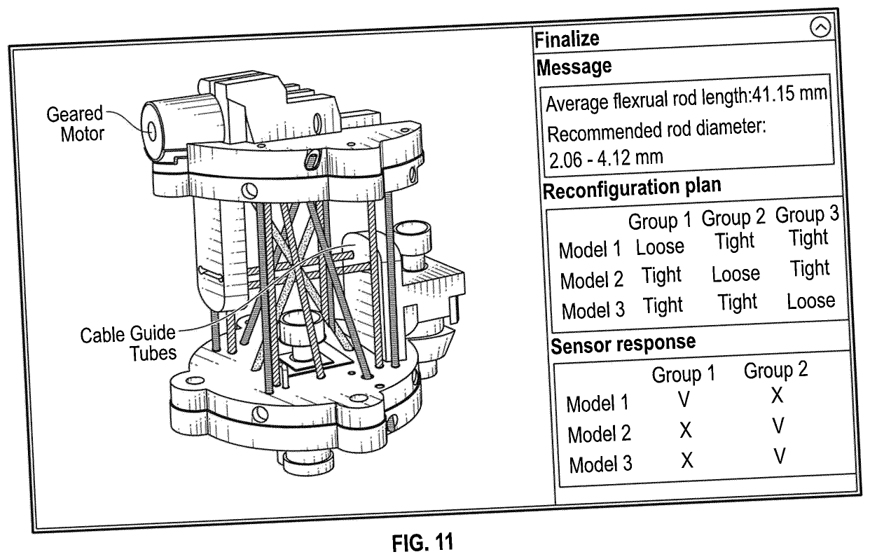

After completing the kinematic mechanism, the method 1 of the present disclosure may prompt the user to assign a thickness to the at least one flexural rod 6. The method 1 may then finalize the model by adding mechanical components 7 (FIG. 11). Exemplary mechanical details the user may add include guiding tubes, anchors for the tensioning cables, housings for geared motors, holes, screw holes for connecting the kinematic joint to a larger system or fixture, wiring for electric cables, and cavities or insertion holes for stiffness-changing rods.

According to certain aspects, the flexural rods may comprise a diameter that is a fraction of the length to ensure sufficient deformability, wherein the ratio of the diameter to the length of the rod may depend on the material choice, intended use of the designed kinematic device, and the like. As example, the flexural rods may comprise a diameter approximately 5-10% of their length to ensure sufficient deformability. The method may prompt the user of the recommended flexural rod diameter range. At this step, the user may modify the rigid stages into any shape so long as the rigid stages are sufficiently stiff. Once a design is completed, the method 1 may modularize the model for printing 8. Exemplary printing methods may include 3-Dimensional printing, laser printing, sintering, Computer Numerical Control (CNC) machining, and injection molding. Manufacturability constraints specific to each exemplary method may apply.

The present disclosure also provides a system comprising a processor and a memory storing computer-readable instructions that, when executed by the processor, cause the processor to trigger execution of program instructions to perform the method 1 of the present disclosure, including, but not limited to: model two rigid stages, assign at least one degree of freedom to at least one kinematic mode, design at least one flexural rod, add mechanical details, and modularize the device for printing.

The present disclosure also provides a computer program product for designing reconfigurable kinematic devices, comprising at least one non-transitory computer readable medium. The computer program product includes program instructions that, when executed by at least one process, cause the at least one process to perform the method 1 of the present disclosure, including, but not limited to: model two rigid stages, assign at least one degree of freedom to at least one kinematic mode, design at least one flexural rod, add mechanical details, and modularize the device for printing.

The method of the present disclosure enables the creation of different types of haptic feedback to achieve human-computer interaction while also enabling linear and rotational motions in all directions. Exemplary types of haptic feedback include weight or volume change, forces, vibrations, and textures. A user may create kinematic haptic proxies that simulate the feel of holding objects made of different materials (FIG. 13A & FIG. 13B).

The present disclosure also relates to a dynamically reconfigurable kinematic device or product designed using the methods disclosed herein. For example, the present disclosure relates to a dynamically reconfigurable kinematic device or product comprising of at least one flexural rod and at least one tunable flexure. The product may optionally comprise at least one stretchable sensor, wherein the resistance of the stretchable sensor is capable of changing. The resistance of the stretchable sensor of the present disclosure may be increased or decreased.

The present disclosure also provides a reconfigurable kinematic device comprising at least two rigid stages, at least one kinematic mode, at least one flexural rod, and at least one tunable flexure. The device may be configured to provide haptic feedback or motion control.

The present disclosure relates to a product, wherein that product may be an input device that may support multiple kinematic interactions at one time.

The product of the present disclosure may have DOF reconfigurability that enables the haptic sensation of different materials in a single device, which enables the product to be compact and portable. Exemplary materials include liquids, elastic rods, and rigid objects.

The product of the present disclosure enables different types of haptic feedback to achieve human-computer interaction while also enabling linear and rotational motions in all directions. Exemplary types of haptic feedback include weight or volume change, forces, vibrations, and textures. The product may have kinematic haptic proxies that simulate the feel of holding objects made of different materials as seen in FIG. 13A & 13B.

The present disclosure provides a wearable device designed by the methods of the present disclosure, wherein at least one tunable flexure comprises at least one stiffness-changing rod. The present disclosure also provides a forearm joint device designed by the methods of the present disclosure, wherein at least one tunable flexure comprises at least one stiffness-changing rod. The present disclosure also provides a wrist joint device and a finger joint device designed by the methods of the present disclosure, wherein the wrist joint device and finger joint device comprise at least one stiffness-changing rod.

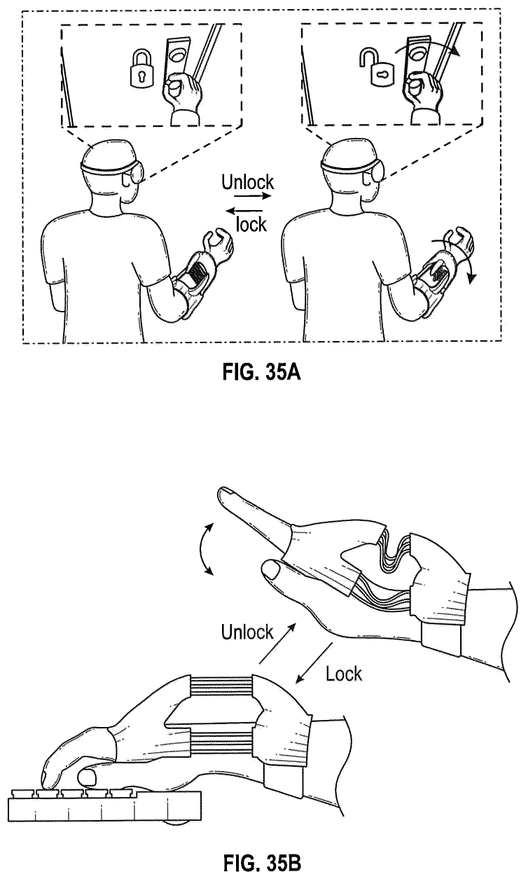

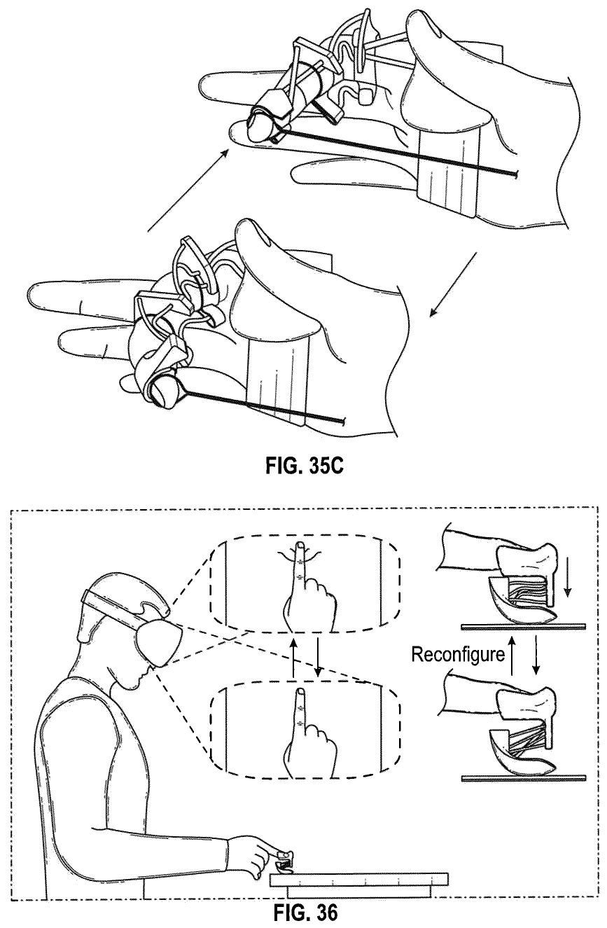

The devices described herein with joint freedom reconfigurability designed using the methods and systems of the present disclosure may be used to create haptic feedback in a virtual or augmented reality environment, for medical treatment, and/or targeted muscle group training. For example, a forearm joint device may be selectively locked or unlocked to simulate the haptics of turning a locked or unlocked doorknob (FIG. 35A). A wrist joint device may be temporarily locked to alleviate and avoid pain from carpal tunnel syndrome when the wearer is using a computer, but the joint may be unlocked to allow free motion when the wearer engages in other activities (FIG. 35B). Finger joints in a finger joint device may be unlocked one at a time to provide targeted joint strength training (FIG. 35C).

As used herein, the term “torque limit” refers to the amount of force that a wearer of a device of the present disclosure may exert. The term “just noticeable difference (JND)” refers to the minimal amount of displacement that the user may perceive at a specific joint. Both torque limit and JND are biomechanical properties that may differ based on the perceptional capabilities of a human being or wearer.

As used herein, the term “degree of displacement” refers the degree in which a device deforms. Degree of displacement may be evaluated through mechanical structural simulations such as finite element analysis to assess structural load against the device materials' strength. The devices designed by the systems and methods of the present disclosure may have a maximum degree of displacement defined by the largest displacement the device may sustain before any constituent elements of the device breaks.

Devices of the present disclosure may displace below the JND when subjected to the torque limit. Thus, a user may not notice any motion at the joint when a user attempts to exercise the joint, since the torque is counteracted by the device's resistance or stiffness. In an unlocked state, a device's stiffness may be sufficiently low to allow the device to deform past the JND with a load below the torque limit. Thus, the wearer of a device of the present disclosure may exercise the joint given their biomechanical limits.

The present disclosure provides a device designed by the systems and methods of the present disclosure comprising at least one stiffness-changing rod, wherein the at least one stiffness-changing rod may be heated or cooled separately to create a reconfiguration mode. Stiffness-changing rods that remain cold may instantiate different levels of stiffness and render the haptic sensation of touching surfaces made of different materials including, but not limited to, foam, rubber, metal, or gelatin.

### Aspects of the Invention

The following aspects are disclosed in this application:

Aspect 1: A method for designing multimodal and reconfigurable kinematic compliant mechanisms, the method comprising the following steps:
modeling two rigid stages of the device;
assigning at least one degree of freedom to at least one kinematic mode;
design at least one flexural rod;
placing at least one tunable flexure;
assigning a thickness to the at least one flexural rod;
adding mechanical details; and
modularizing the model for printing.

Aspect 2: The method of aspect 1, further comprising the step: optionally adding at least one elastic sensing cable.

Aspect 3: The method of aspect 2, wherein the elastic sensing cables comprise any stretchable sensor, wherein the resistance of the stretchable sensor is increased or decreased.

Aspect 4: The method of any one of aspects 1 to 3, wherein the two ridged stages comprise one fixed end and one free end.

Aspect 5: The method of any one of aspects 1 to 4, further comprising the step: assigning a thickness to the at least one flexural rod having a diameter of 5% to 10% of a length of the at least one flexural rod.

Aspect 6: The method according to any of the foregoing aspects, wherein the at least one tunable flexure comprises a stiffness-changing rod.

Aspect 7: The method according to any of the foregoing aspects, wherein the at least one tunable flexure comprises a tensioning cable.

Aspect 8: The method according to any of the foregoing aspects, the stiffness-changing rod comprising a metallic resistive heating wire.

Aspect 9: The method according to any of the foregoing aspects, wherein the metallic resistive heating wire heats the stiffness-changing rod to at least a low glass transition temperature, wherein the at least one stiffness-changing rod becomes mobile in the axial direction.

Aspect 10: The method according to any of the foregoing aspects, wherein the tensioning cables may be tightened or loosened to reconfigure the device's Degrees of Freedom, wherein tightening a tensioning cable constrains extension.

Aspect 11: The method according to any of the foregoing aspects, wherein the at least one tensioning cable does not provide constraint, and wherein the at least one tensioning cable allows at least one degree of freedom previously disabled.

Aspect 12: The method according to any of the foregoing aspects, further comprising the step: configure a device in 3-dimensional space defined by six numbers, wherein the device has up to five Degrees of Freedom and at least one Degree of Constraint.

Aspect 13: The method of any one of the foregoing aspects, further comprising the step: enable a user to modularize the kinematic device for printing, wherein the method of printing is selected from a group of methods consisting of conventional 3-Dimensional printing, laser printing, sintering, Computer Numerical Control (CNC) machining, and injection molding.

Aspect 14: A non-transitory memory comprising processor-executable instructions; and a processor coupled to the non-transitory memory and configured to execute the process-executable instructions, wherein the processor-executable instructions comprise instructions to execute the method according to any one of aspects 1 to 13.

Aspect 15: A non-transitory memory comprising processor-executable instructions; and a processor coupled to the non-transitory memory and configured to execute the process-executable instructions, wherein the processor-executable instructions comprise instructions to:
model two rigid stages of the device;
assign at least one Degree of Freedom to at least one kinematic mode of the device;
design at least one flexural rod;
place at least one tunable flexure;
assign a thickness to the at least one flexural rod;
add mechanical details; and
modularize the model for printing.

Aspect 16: The system of aspect 15, wherein the processor-executable instructions further comprise instructions to optionally add elastic sensing cables.

Aspect 17: The system of aspect 16, wherein the elastic sensing cables comprise any stretchable sensor, wherein the resistance of the stretchable sensor is increased or decreased.

Aspect 18: The system of any one of the foregoing aspects, wherein the two ridged stages are comprised of one fixed end and one free end.

Aspect 19: The system of any one of the foregoing aspects, wherein the processor-executable instructions further comprise instructions to assign a thickness to the at least one flexural rod having a diameter of 5% to 10% of a length of the at least one flexural rod.

Aspect 20: The system of any one of the foregoing aspects, wherein the tensioning cables may be tightened or loosened to reconfigure the device's Degrees of Freedom, wherein tightening a tensioning cable constrains extension.

Aspect 21: The system of aspect 20, wherein loosening a tensioning cable removes all constraining effects.

Aspect 22: The system of any one of the foregoing aspects, wherein the processor-executable instructions further comprise instructions to configure a device in 3-dimensional space defined by six numbers, wherein the device has up to five Degrees of Freedom and at least one Degree of Constraint.

Aspect 23: The system of any one of the foregoing aspects, wherein the processor-executable instructions further comprise instructions to enable a user to modularize the kinematic device for printing, wherein the method of printing is selected from a group of methods consisting of conventional 3-Dimensional printing, laser printing, sintering, Computer Numerical Control (CNC) machining, and injection molding.

Aspect 24: A product comprising of at least one flexural rod and at least one tunable flexure.

Aspect 25: The product of aspect 20, further comprising of at least one elastic sensing cable, wherein the elastic sensing cable comprises of any stretchable sensor, wherein the resistance of the stretchable sensor is capable of changing.

Aspect 26: The product of aspect 21, wherein the tensioning cable enables a user to adjust the function of the product.

Aspect 27: The product of aspect 21 or 22, wherein the at least one tunable flexure and the elastic sensing cable enables a user to adjust the function of the product.

Aspect 28: A dynamically reconfigurable kinematic device designed according to the method of any one of the foregoing aspects or using the processor-executable instructions of any one of the foregoing aspects.

Aspect 29: A casting jig for fabricating a stiffness-changing rod, the casting jig comprising at least one hemicylindrical groove, at least one alignment feature at each end of the groove, at least one securing screw, and at least one nut.

Aspect 30: A casting jig according to aspect 29, wherein a heating wire may be aligned within the at least hemicylindrical groove.

Aspect 31: A casting jig according to any of the foregoing aspects, wherein the at least one alignment feature at each end of the groove positions the at least one heating wire in the center of the stiffness-changing rod.

Aspect 32: A stiffness-changing rod according to any of the foregoing aspects, the stiffness-changing rod comprising: epoxy resin, a crosslinker, and a heating wire.

Aspect 33: A stiffness-changing rod according to any of the foregoing aspects, wherein the epoxy resin and crosslinker are present in a weight ratio of 10:4.

Aspect 34: A device according to any of the foregoing aspects, comprising a stiffness-changing rod, wherein the stiffness-changing rod may be heated.

Aspect 35: A device according to any of the foregoing aspects, comprising a stiffness-changing rod, wherein the stiffness-changing rod may be cooled.

Aspect 36: A device according to any of the foregoing aspects, comprising a stiffness-changing rod and at least one relay.

Aspect 37: A device according to any of the foregoing aspects, comprising a stiffness-changing rod and at least one transistor.

Aspect 38: A wearable device designed according to any of the foregoing aspects, wherein the at least one tunable flexure comprises at least one stiffness-changing rod.

Aspect 39: A forearm joint device designed according to any of the foregoing aspects, wherein the at least one tunable flexure comprises at least one stiffness-changing rod.

Aspect 40: A wrist joint device designed according to any of the foregoing aspects, wherein the at least one tunable flexure comprises at least one stiffness-changing rod.

Aspect 41: A finger joint device designed according to any of the foregoing aspects, wherein the at least one tunable flexure comprises at least one stiffness-changing rod.

Aspect 42: A haptic thimble device designed according to any of the foregoing aspects, wherein the at least one tunable flexure comprises at least one stiffness-changing rod.

Aspect 43: A kinematic device comprising: at least two rigid stages, at least one kinematic mode, at least one flexural rod, and at least one tunable flexure, wherein the device is configured to provide haptic feedback or motion control.

Aspect 44: The kinematic device according to aspect 43, wherein the tunable flexure is a stiffness-changing rod.

Aspect 45: The kinematic device according to aspect 44, wherein the stiffness-changing rod is heated or cooled to provide compression in at least one kinematic mode.

### EXAMPLES

### Example 1: A Kinematic Device Designed by the Systems and Methods of the Present Disclosure

We designed a multimodal input device (FIGS. 4A-C). The device had three kinematic modes—slider, joystick, and dial knob—that provided different interaction affordances, and all of the functionalities were present within a single compliant mechanism joint. The algorithms of the methods and systems of the present disclosure were implemented in Rhinoceros 3D with plugins (Grasshopper, Human UI, and CPython).

The workflow started with modeling the two rigid stages—a fixed and a free end—of the kinematic device (FIG. 4A), which were left plain at the beginning since the cables, motor housings, and flexural rods were added in later steps. The user started by creating three DOF modes for this device (FIG. 5). The first mode approximated a joystick, which allowed for rotations about any axis on the x-y plane that passed through the center of the mechanism. To represent these freedoms, the user added several possible rotation axes to the design tool, which in return visualized the freedom space for the user (FIG. 6A). Similarly, the user assigned a z-axis rotation to the second kinematic mode to simulate a dial knob, and a translational motion along the x-axis to the third mode as a slider (FIG. 6B).

Once the user specified the DOFs of all kinematic modes, the design tool then proceeded to guide the user through designing the flexural rods. These rods were shared by all kinematic modes and are not reconfigurable. The constraint space visualization suggested the location and orientation of permitted rod placements, and the flexures were placed iteratively until the constraint spaces were satisfied and complete (FIG. 7). In this case, the methods and systems of the present disclosure prompted the user to add at least two rods that pass through the center point and lie on the y-z plane. If the user placed a rod in an invalid position or orientation, the CM would have been over- and ill-constrained, and the design tool would have highlighted and prompted the user to correct it (FIG. 8).

Following placing the flexural rods, the design tool guided the user to place tensioning cables that reconfigure the kinematic device (FIG. 9A & 9B). The tensioning cables were assigned into groups that were actuated together, which also produced a reconfiguration plan for the kinematic modes. When adding the cables, unlike the flexural rod placements, the user retained more freedom to decide where to place the tensioning cables as long as their directions followed the design rules. If the tensioning cables must be added in pairs to balance their loads, the methods generated a coerced twin-cable whenever the user placed one tensioning cable. The tool also prompted the user when the cable placement was invalid.

The user had the option to add stretchable sensors to the CM to convert it into an input device. According to certain aspects, the design tool also provided guidance to help the user place the sensors in appropriate orientations. The rules and textual prompts were similar to that of the tensioning cables. However, the design tool provided a panel to preview which DOF's motion was detectable given the current setup (FIG. 10). The design tool also instructed the user which sensors may be stretched along a DOF, which informed the circuit logic and controller firmware design. FIG. 10 shows the user added three pairs of sensors to detect the deformations of each kinematic mode.

Once the kinematic mechanism was completed, the user proceeded to finalize the model by adding mechanical components and assigning thicknesses to the flexural rods (FIG. 11). In this example, the rods had a diameter of 2 mm, which was approximately 5% of their length to ensure sufficient deformability. The user had freedom to modify the rigid stages into any shapes given they were sufficiently stiff. In this design, the user added guiding tubes and anchors for the cables, housings for the geared motors, and insertion holes. The mechanism was also divided into four parts for 3D printing.

### Example 2: Multimodal Input Device

We demonstrated that as a multimodal interface, an input device created using the methods and systems of the present disclosure supported various kinematic interactions at a time. The device was capable of change between three kinematic modes on demand, each recreated the haptic experience of using a common interface (i.e., joystick, slider, twisting knob).

Three sets of tensioning cables were used in this design, and it had six stretchable sensors to detect the user's action. The reconfiguration took less than a second, achieving almost real-time modality change. In other embodiments, the system may optimize the flexure dimension or choose a more deformable flexure rod material to achieve a more comfortable interaction. Taking advantage of the device's mechanical simplicity, may further miniaturize the design to embed it into commercial products (e.g., video game controllers) and enable more dynamic interaction experiences.

### Example 3 Kinematic Material Display

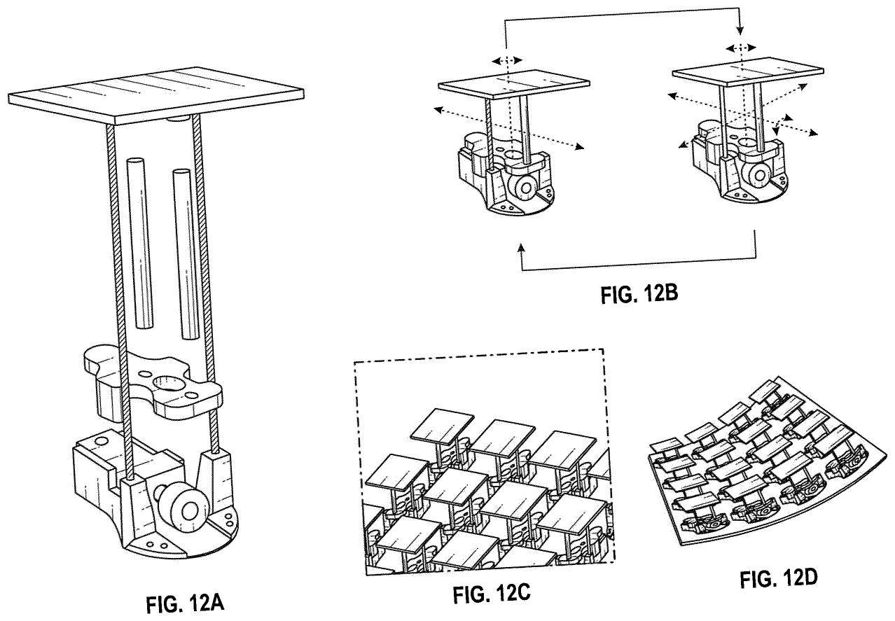

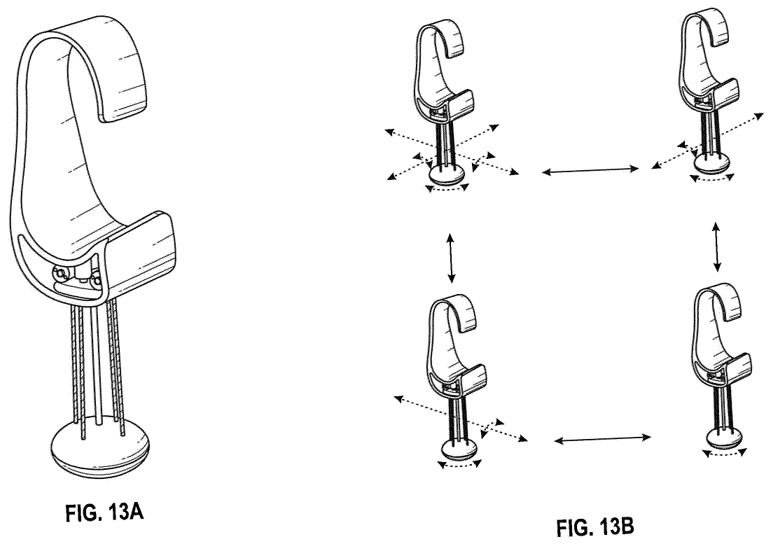

In this example, we leveraged the compactness and reconfigurability of the systems and methods to create a kinematic material device. Different from conventional displays that render images or shape displays that physicalize geometries, this kinematic display was used to tangibilize the kinematic freedoms of a piece of material (i.e., an object's deformability when touched by hands). The display was made of a 4×4 grid of individually addressable kinematic bits (FIG. 12A), and the modules had a pair of cables to enable/disable their translational and rotational degree of freedom (FIG. 12B, 12C, & 12D). When the cables were loosened, the interface had the kinematic affordance of mud, whereas when tightened, the display simulated stiff dried soil.

Compared to the inForm table (Sean Follmer, 2013) that provided kinematic response by actuating linear pins, the device created by the systems and methods of the present disclosure afforded more kinematic motions such as bending and twisting while having a smaller footprint. The display wrapped around nonplanar surfaces when sewed onto a fabric substrate (FIG. 12D). According to certain aspects, the systems and methods of the present disclosure may incorporate actuatable tendons to further instrumentalize this design.

### Example 4: Wearable Haptic Proxy

We demonstrated that the systems and methods of the present disclosure may also be used to create kinematic haptic proxies that simulate the hand feel of holding objects made of different materials (FIG. 13A). The device was attached with a weight of 80 grams, which allowed it to swing in different directions depending on the tensioning cable configuration (FIG. 13B). Specifically, the weight was immobile when all cables were tightened and was free to rotate or translate along five DOFs when fully unlocked. This design allowed us to simulate the weight shift of holding different objects including liquids, elastic sticks, and rigid bars. It is worth noting that the mechanical simplicity of our design led to a substantial reduction of assembly demand and device weight: it consisted of only three printed parts, two mini-motors, and weighed 101.3 g, compared to a device designed with more than four parts, four motors, and weighed 814.4 g in ElaStick (Neung Ryu, 2020). The systems and methods of the present disclosure enabled creation of light weight haptic proxies. Moreover, the device's design freed the user's fingers to interact with other possible interfaces (e.g., texture, vibration), which permitted a more immersive experience. This design may also be applicable in virtual or mixed reality.

### Example 5: Fabrication of Devices

We used a desktop 3D printer (Ultimaker S5) and off-the-shelf filaments (Ultimaker PLA) to fabricate the devices. The flexural rods and rigid stages were printed as separate parts and assembled to form the devices. CMs could have been made using any fabrication method and material given adequate resolution and structural properties (e.g., resilience, stiffness, deformability), and other additive manufacturing methods like laser sintering (metal or plastics) or digital light processing (resin) could have also been used to fabricate CMs, potentially as a single piece to further reduce the assembly labor. Nylon fishing lines were used for the tensioning cables.

The tensioning cables were modulated using geared motors (ROB-12285, SparkFun Electronics), which were controlled by an Arduino board and an H-bridge (BD62130AEFJ-E2, Rohm Semiconductor). The geared motors had a gear ratio of 298:1, and due to its high reduction ratio, the motor only required power during reconfiguration, thus making them power-efficient when idle. The stretch sensors (product Id: 519) were purchased from Adafruit and had a resistance of 350 ohms per inch and a maximum strain of 70%. The sensor's resistance increased as a function of its strain and could be mapped to a CM's deformation.

### Example 6

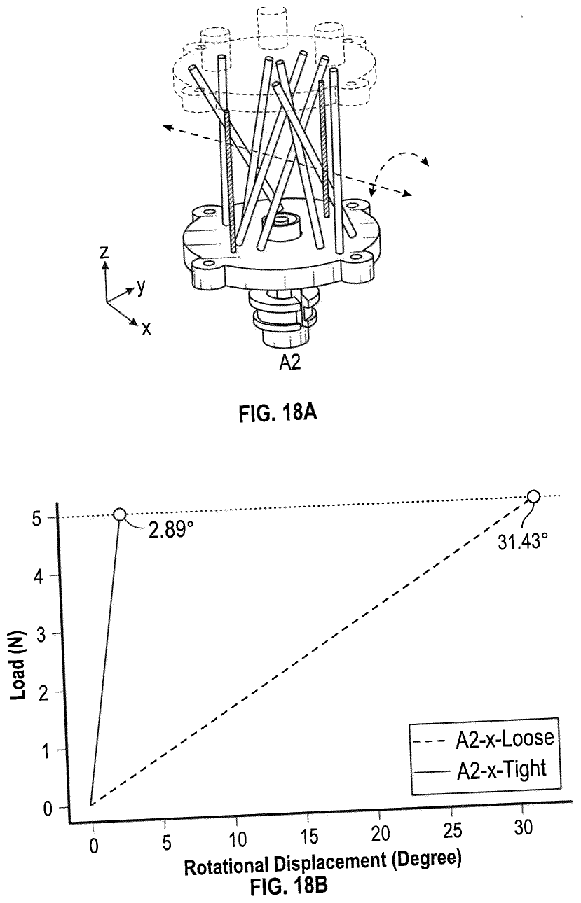

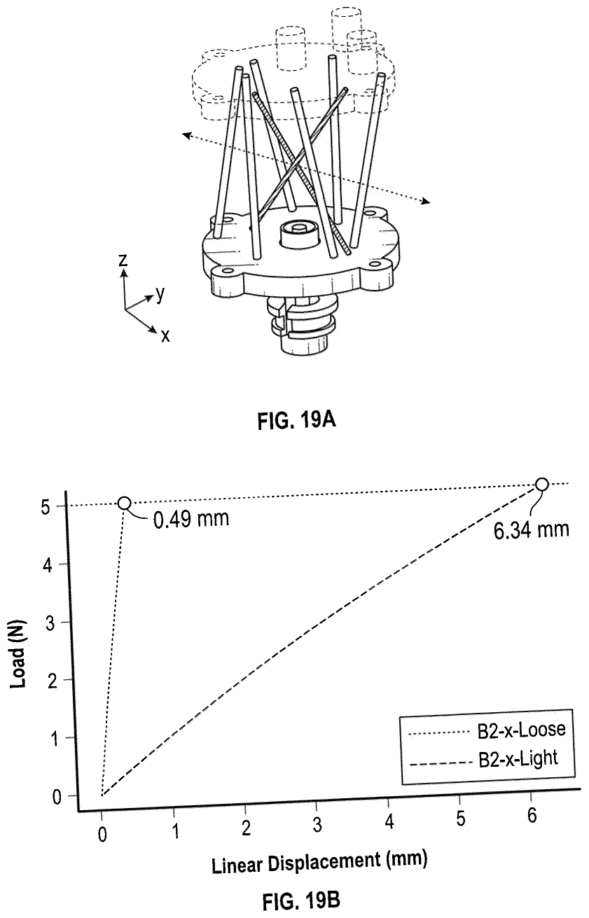

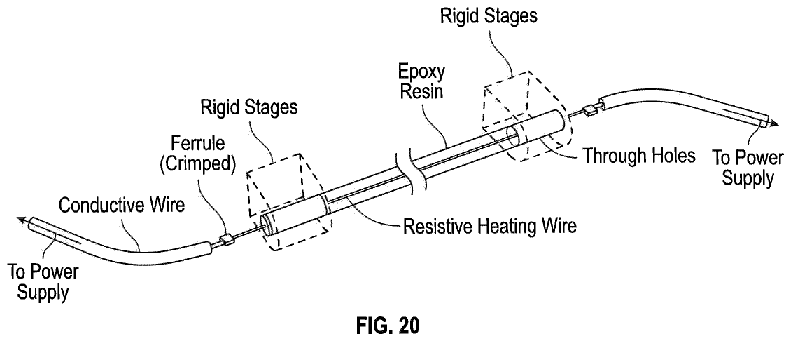

We evaluated the effectiveness of the system and methods of the present disclosure in terms of prescribing DOFs and the cable-driven reconfiguration. The passive CMs (i.e., A1, B1 and C1) in FIG. 17A were used to verify the desired DOFs while the CMs with cables (i.e., A2 and B2) were tested for their reconfigurability (FIGS. 18A, 19A). We used a 3D-printed rig to adapt our CM devices to the testing system (Instron 5969). The samples were mounted on a slider to make sure the point of force application remained lined up with the machine. A maximum tensile load of 5 N was set for all tests. Extensions measured by the system were converted into bending angles for the rotational DOFs.

The test samples A1 and B2 were designed to validate that the framework could produce the targeted rotational and translational DOF. They were designed with a rotation about the x-axis and a translation along the x-axis, respectively. The mobilities along all six DOFs were evaluated for both samples and could be examined by their deformation over load, i.e., the slope of the curves. A steep curve suggested that the mechanism is less mobile along that direction, whereas a more gradual curve indicated freedom. FIGS. 17B and 17C demonstrated that both samples were much more compliant along their prescribed motional axes. Compared to their constrained motions, both of the samples had a 5-6× higher deformation under the same load along its DOFs. Specifically, A1 had more than 30 degrees of rotation about its mobile x-axis, whereas the same deformation was almost indiscernible (smaller than 6 degrees) in other directions. Similarly, B1 translated more than 6 mm along its mobile axis while the deformation was less than 0.5 mm in the other directions.

On the other hand, sample C1 was designed with a rotational DOF along the z-axis and a translation DOF along the x-axis, and it was used to validate that the design tool could produce a single mechanism with multiple DOFs. Based on the results, determined that the sample was much more mobile along the two prescribed DOFs compared to the others, thus proving that the sample was successfully made mobile in the two targeted DOFs and was constrained in the other four. These results demonstrated that the systems and methods of the present disclosure was capable of creating kinematic mechanisms with the desired DOFs.

The test samples A2 (FIG. 18A) and B2 (FIG. 19A) were designed with the same DOFs and flexural rod layout as their counterparts in the earlier experiments, A1 and B2, respectively. However, their DOFs could be enabled or disabled by loosening or tightening the cables, which were placed per the design tool's suggestions. FIG. 18B demonstrated that under the same load, the maximum rotational angle of A2 was 31.43 degrees when it was unlocked, but the mobility dropped to 2.89 degrees when the cables were tightened. B2 also showed a similar trend: under the same load, B2's translation along the x-axis dropped from 6.34 mm to 0.49 mm when it was locked (FIG. 19B). These results indicated that the cable-driven reconfiguration is viable, and the guidance of the systems and methods of the present disclosure was truthful.

### Example 7: Wearable Device for Haptics, Medical Treatment, and Medical Training

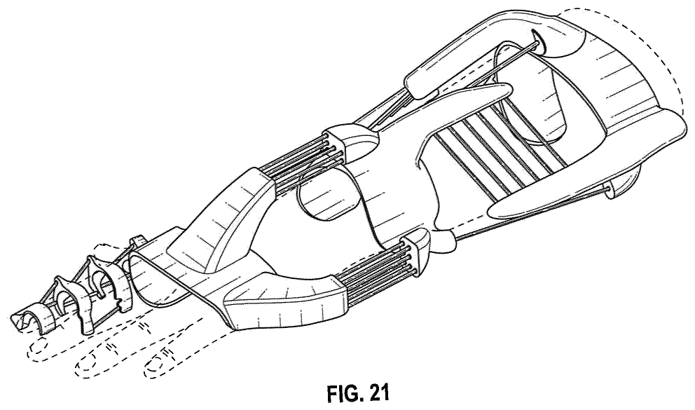

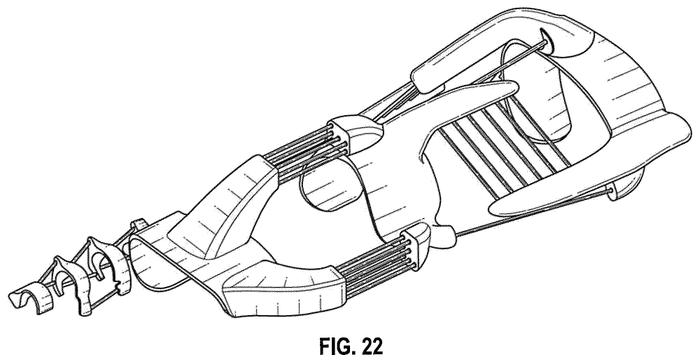

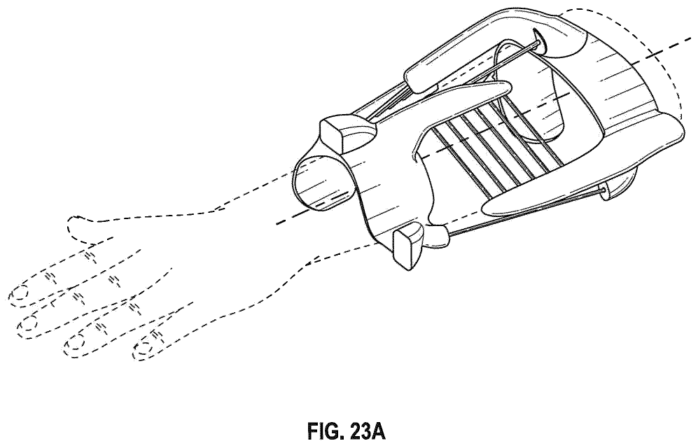

Using the systems and methods of the present disclosure, we designed a wearable device that may be worn on the forearm, hand, and finger that is capable of selectively enabling and disabling motions at individual joints (FIGS. 21 & 22).

The kinematics were defined by the human skeletal structure: all joints were afforded a rotational motion except for the wrist joint, which allowed rotation about two axes. The flexure placements were determined and suggested by the systems and methods of the present disclosure. Redundant flexures were added to provide a targeted level of resistance based on the biomechanical criteria of an abled body adult. When designing wearable devices around body joints, the joints' freedoms were exactly constrained by the skeletal structure, which corresponded to the shared flexures in the systems and methods of the present disclosure. All flexures had a diameter of 2 mm.

The design criteria considered the torque limit and the proprioception just noticeable difference (JND) of individual joints. The torque limit was considered to be the amount of force that the wearer may exert, and the JND was considered to be the minimal amount of displacement that the user could perceive at a specific joint.

The design of the locked state ensured the device displaced below the JND when subjected to the torque limit. Thus, the user was not able to notice any motion at the joint when the user attempted to exercise the joint, since the torque was counteracted by the device's resistance (i.e., stiffness). In the unlocked state, the device's stiffness was not sufficiently low to allow the device to deform past the JND with a load below the torque limit, which indicated that the user/wearer could exercise the joint given the wearer's biomechanical limits.

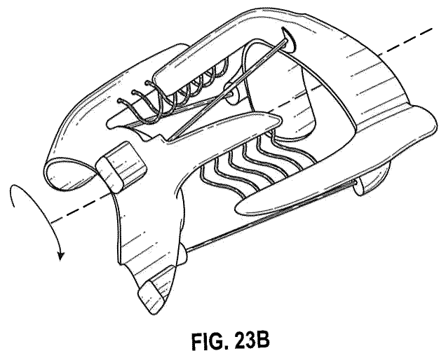

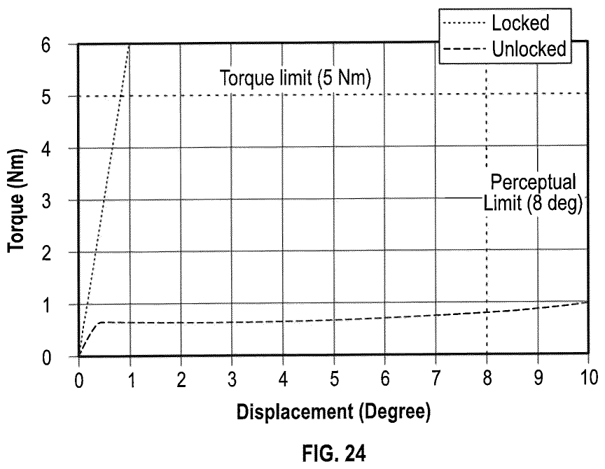

The forearm joint was designed to lock and unlock the axial rotation of the forearm (FIG. 23). The device comprised tunable flexures comprising stiffness-changing rods. In addition to the stiffness-changing rods, three passive (non-configurable) flexures were added to maintain the spacing between the two rigid stages. The placement conformed to the axial rotation's constraint space, neither locking nor unlocking the motion. Finite Element Analysis (FEA) was used to evaluate and verify the device against the design criteria (FIG. 24). In the locked state, the device did not deform more than 1 degree when subjected to the targeted torque limit of 5 Nm. The deformation was well below the proprioception JND of 8 degrees. Thus, the wearer could have perceived the joint as being virtually locked and immobile. In the unlocked state, the joint could easily move past the proprioception JND with a load below the torque limit, and the wearer would have perceived the joint as unlocked and mobile.

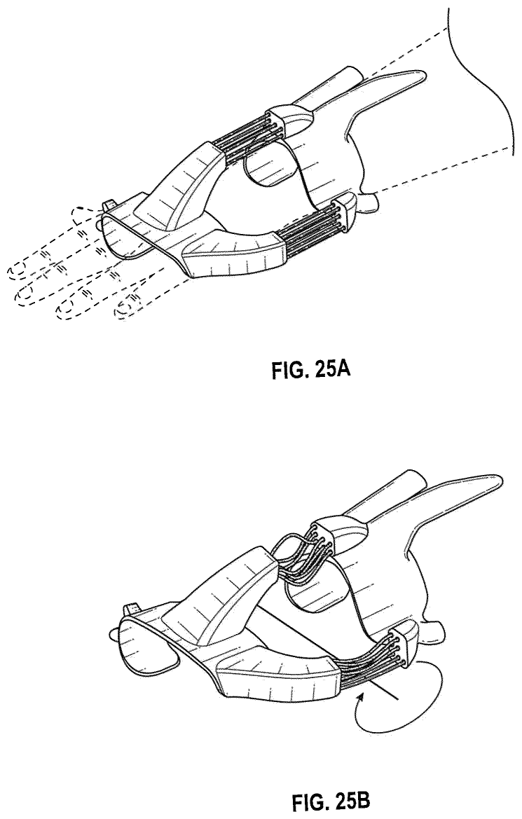

The wrist joint device (FIG. 25) comprised two rotational DOFs, one that tilts the palm vertically (flexion) and another that deflects the palm sideways (deviation). The two DOFs were regarded as independent kinetic freedoms that could be individually locked and unlocked, leading to four reconfiguration modes (FIGS. 25A-D). The systems and methods of the present disclosure suggested three constraint subspaces for placing stiffness-changing rods, wherein the shared constraint subspace was already satisfied by the skeleton.

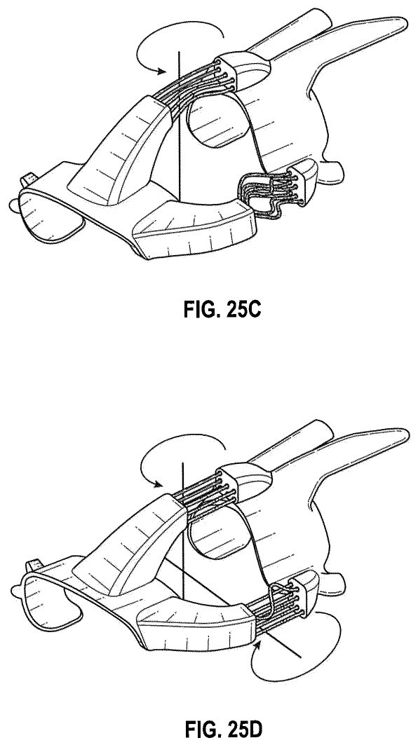

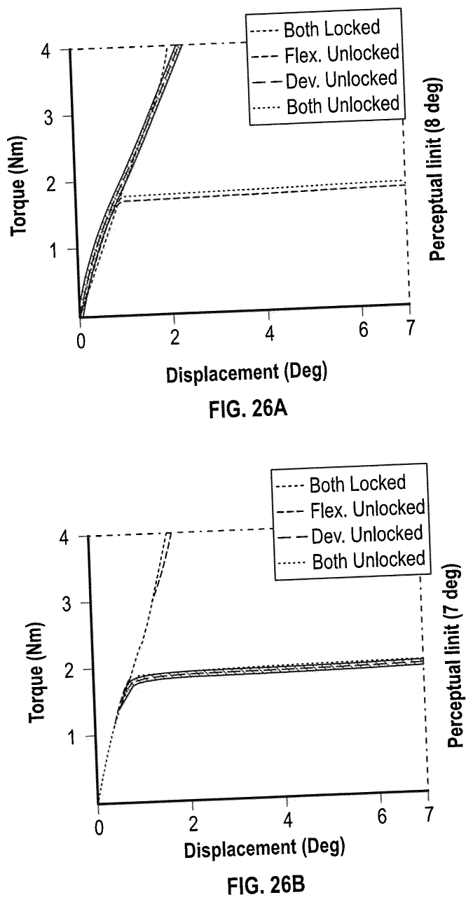

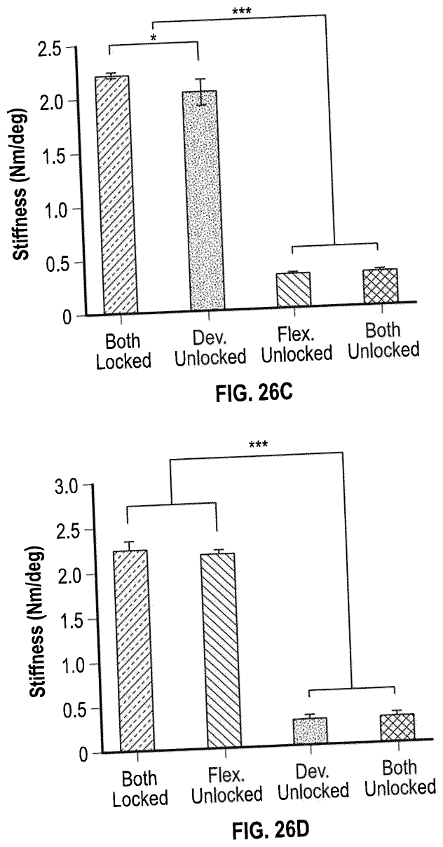

The wrist joint device design was verified by both FEA and mechanical tests. The device was fabricated and jigged for mechanical testing using an Instron machine. The FEA and experimental data verified that both the locking and unlocking modes had reached their design criteria (FIG. 26A-26D). When the DOFs were configured in opposition (i.e., one DOF on and the other off), the locked DOFs remained proprioceptionally immobile while the unlocked DOF became mobile, verifying that the DOFs were individually reconfigurable. The joint also had a similar stiffness along a DOF regardless of the lock-unlock states of the other DOF.

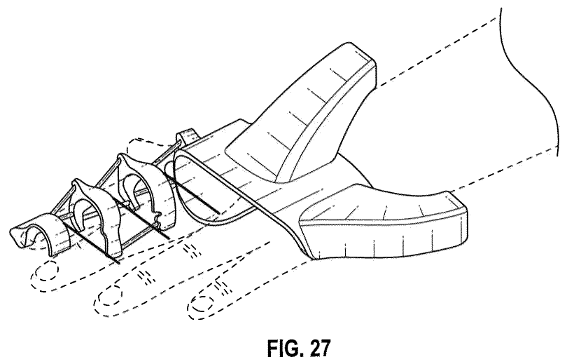

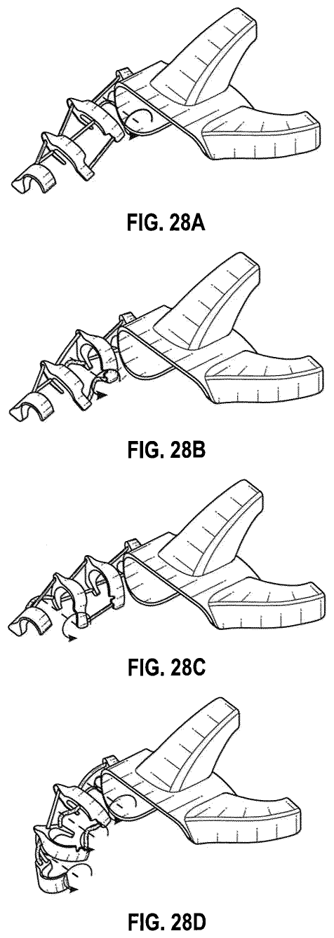

The finger joint device comprising the finger joints proximal interphalangeal (PIP), metacarpophalangeal (MP), and distal interphalangeal joints (DIP) was designed to control rotations about an axis and share an identical flexure layout (FIG. 27). Each of the finger joints were independently and selectively unlocked for different haptic experiences (FIGS. 28A through 28D).

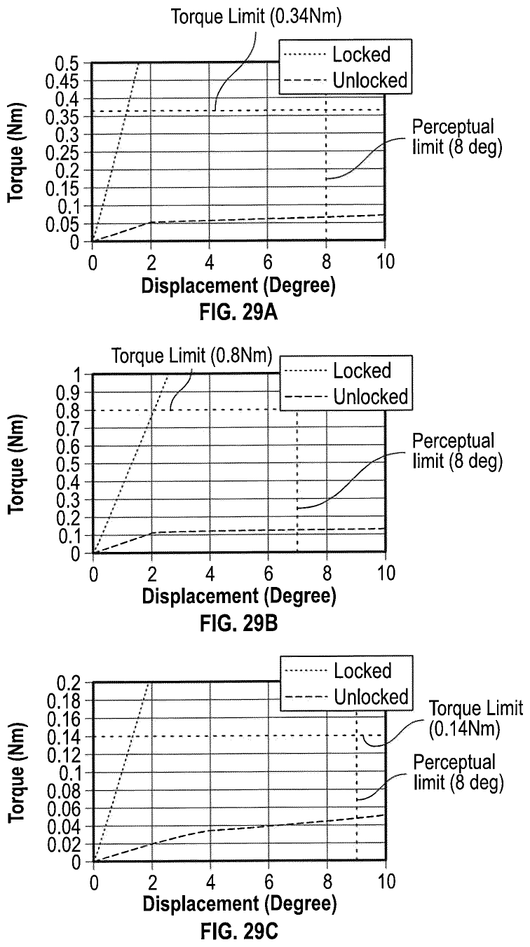

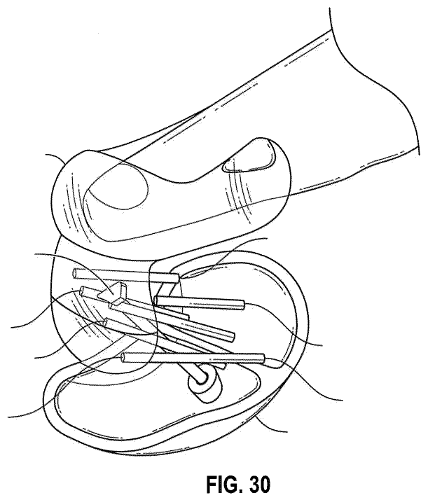

For the finger joints, a passive flexure was placed at each joint according to the rotation's constraint space to maintain the spacing between stages, and the stiffness-changing rods were placed at the compressive side as suggested by the systems and methods of the present disclosure. The placement of the stiffness-changing rods was adjusted to provide a suitable level of resistance according to each joint's torque limits. The distance of the stiffness-changing rods was adjusted to the rotation axes to satisfy the design threshold without changing the orientation. For example, the further away from the rotation axis, the more resistance a stiffness-changing rod could provide in the locked state. The MP joint required two stiffness-changing rods to reach the targeted level of stiffness, while the PIP and DIP joints required only one stiffness-changing rod. FEA simulation verified that all joint designs satisfied the design criteria of the locked and unlocked states (FIG. 29A through FIG. 29C).

The forearm, wrist, and finger joint devices described herein with joint freedom reconfigurability designed using the methods and systems of the present disclosure may be used to create haptic feedback in a virtual or augmented reality environment, for medical treatment, and/or targeted muscle group training. For example, the forearm joint may be selectively locked or unlocked to simulate the haptics of turning a locked or unlocked doorknob (FIG. 35A). The wrist joint may be temporarily locked to alleviate and avoid pain from carpal tunnel syndrome when the wearer is using a computer, but the joint may be unlocked to allow free motion when the wearer engages in other activities (FIG. 35B). The finger joints may be unlocked one at a time to provide targeted joint strength training (FIG. 35C).

### Example 8: A Haptic Thimble with Stiffness-Changing Rods

The systems and methods of the present disclosure were used to design a thimble that could be worn at the finger to simulate the haptic experience of touching difference softness levels of surfaces (FIG. 36). The touch was modeled as a linear translation perpendicular to the finger pulp. However, we acknowledged that the motion might deviate from the axis depending on how a wearer applied forces. Thus, we modeled the motion as a two DOF translation long the plane that coincides with the finger. The device was designed with a force limit of that exerted in an explorative task (25N), and the displacement was limited to 5 mm.

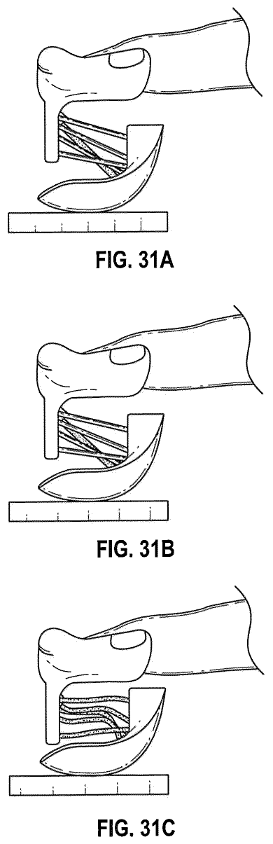

The flexures were added according to the suggestion of the methods and systems of the current disclosure. We added four symmetric (about the finger-plane) pars of stiffness-changing rods 1.5 mm in diameter with slightly different orientations and positions to create different levels of stiffness against motion. An additional stiffness-changing rod 2 mm in diameter was added to the finger-plane to provide higher stiffness in the fully locked state. Each group of stiffness-changing rods could be heated or cooled separately, leading to 2⁵ reconfiguration modes. The systems and methods of t present disclosure was used to ensure all stiffness-changing rods were subjected to compressive loads in all configurable modes. Depending on the configuration, the rods that remained cold would instantiate different levels of stiffness and render the haptic sensation of touching surfaces made of different materials (FIGS. 31A through 31C).

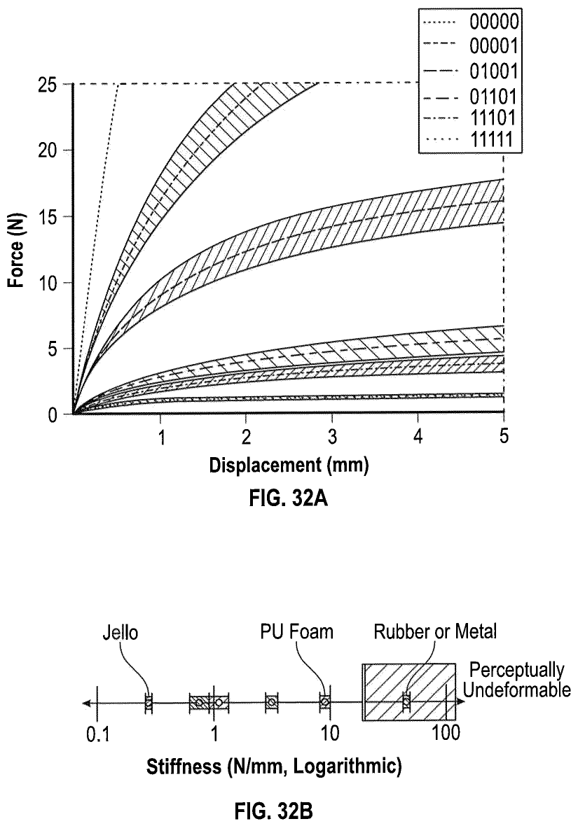

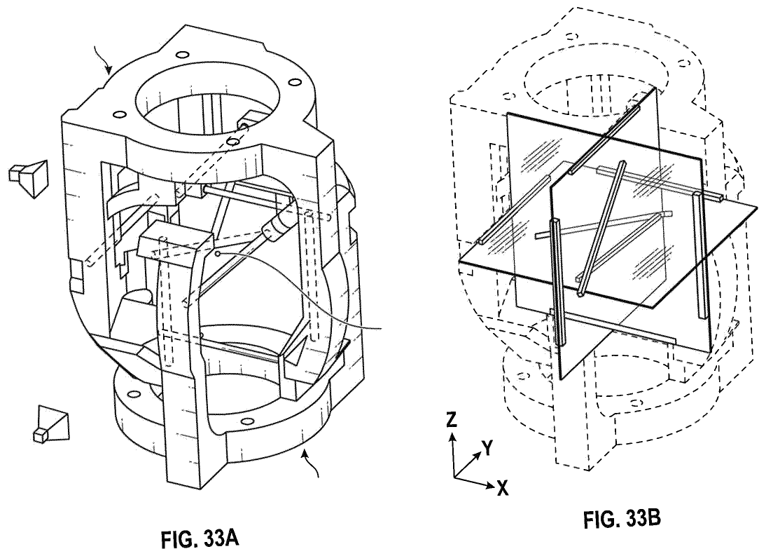

The device was printed, jigged, and tested on an Instron machine to measure the load-displacement relationship (FIG. 32A). We tested a subset of the reconfigurable modes to find the range of stiffness afforded by the design. Between the most rigid and compliant modes, the calculated stiffness varied by 170.31 times, from 0.27 N/mm to 46.5 N/mm. Assuming the forces were applied through a fingertip area of 10 mm square, the resulting pressure varies between 54.5 MPa to 10 MPa, which corresponds to the elastic properties of a gelled solution of gelatin and rubber, respectively (FIG. 32B). The device's rigidity in the stiffest state exceeded the human perceptual limit, which was a just noticeable difference of 0.05 mm/N in compliance, which rendered the device virtually undeformable by the human finger. Thus, the stiffest state may be used to simulate the haptics of touching materials stiffer than rubber, such as rigid plastics and metal. The device would be further used to simulate haptic feedback of touching different objects in virtual environments (FIG. 36).

### Example 9: A Reconfigurable 6-DOF Joint Design

The systems and methods of the present disclosure were used to design a device to lock and unlock any of the six motional degrees of freedom in the 3-dimensional space (FIG. 33). Each of the DOFs was specified as a reconfigurable kinematic mode as input to the systems and methods of the present disclosure. Flexures were added following the suggestions of the systems and methods of the present disclosure. The resulting design used nine stiffness-changing rods and no passive flexure, and the two rigid stages had the same geometry but were oriented differently. The six DOFs were individually locked and unlocked by heating different subsets of stiffness-changing rods.

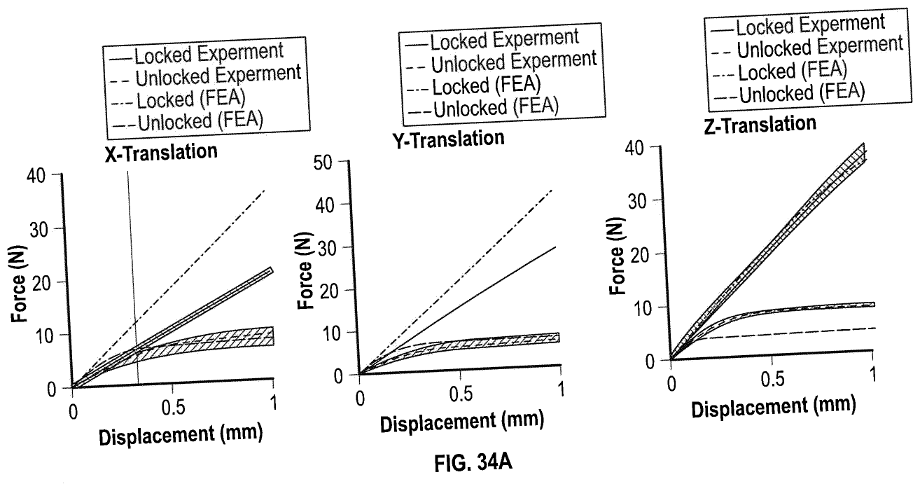

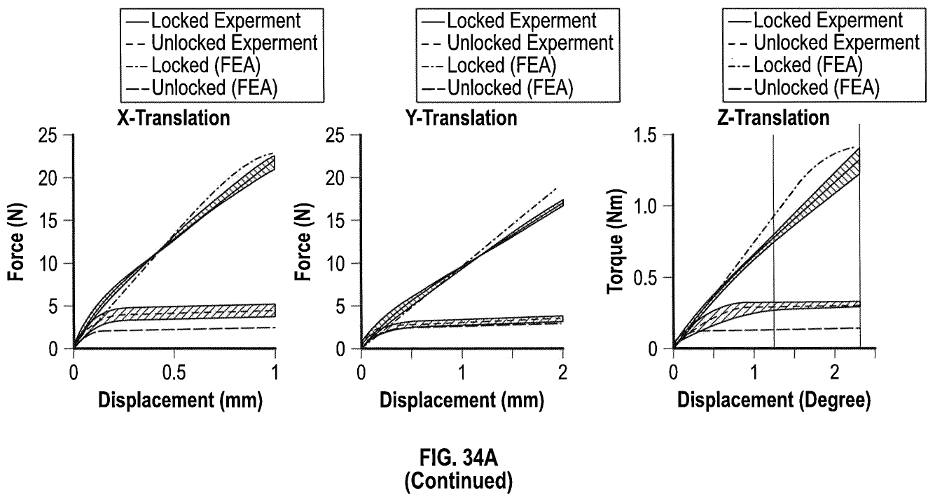

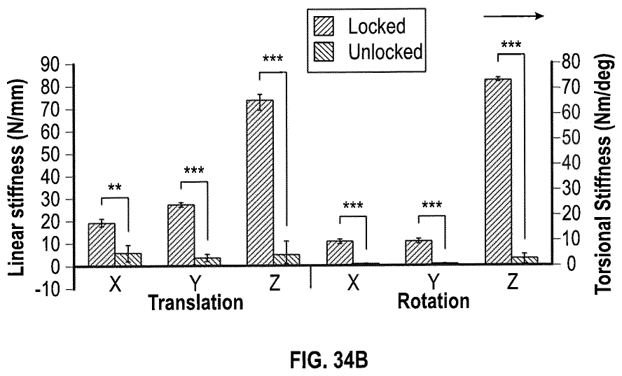

The device's performance was validated through physical prototypes and mechanical tests. The device provided a high stiffness along each of the six DOFs when the rods were cold. Depending on how the rods were configured, the device would still become mobile in the targeted DOF. When comparing the stiffness between the locked and unlocked states, statistically significant differences had also been observed across all DOFs, demonstrating that DOG locking was effective ((FIG. 34) (*p<0.05, **p<0.01, ***p<0.001)).

### REFERENCES

Neung Ryu, Woojin Lee, Myung Jin Kim, and Andrea Bianchi. 2020. ElaStick: A Handheld Variable Stiffness Display for Rendering Dynamic Haptic Response of Flexible Object. In Proceedings of the 33rd Annual ACM Symposium on User Interface Software and Technology (UIST '20), 1035-1045.
Frederick Sun and Jonathan B. Hopkins. 2017. Mobility and Constraint Analysis of Interconnected Hybrid Flexure Systems Via Screw Algebra and Graph Theory. Journal of mechanisms and robotics 9, 3. https://doi.org/10.1115/1.4035993

What is claimed is:

1. A method of designing a multimodal and reconfigurable kinematic device, the method comprising:
modeling two rigid stages of the device;
assigning at least one degree of freedom to at least one kinematic mode of the device;
designing at least one flexural rod;
placing at least one tunable flexure;
assigning a thickness to the at least one flexural rod;
adding mechanical details; and
modularizing the device for printing.

2. The method of claim 1, further comprising, optionally adding at least one elastic sensing cable.

3. The method of claim 2, wherein the at least one elastic sensing cable comprises a stretchable sensor, wherein resistance of the stretchable sensor is increased or decreased.

4. The method of claim 1, wherein the at least one tunable flexure comprises a tensioning cable.

5. The method of claim 1, wherein the at least one tunable flexure comprises a stiffness-changing rod.

6. The method of claim 5, the stiffness-changing rod comprising a metallic resistive heating wire.

7. The method of claim 6, wherein the metallic resistive heating wire heats the stiffness-changing rod to at least a glass transition temperature, wherein the stiffness-changing rod becomes mobile in the axial direction.

8. The method of claim 1, wherein the two rigid stages are comprised of a fixed end and a free end.

9. The method of claim 1, further comprising:
assigning a thickness to the at least one flexural rod having a diameter of 5% to 10% of a length of the at least one flexural rod.

10. The method of claim 4, wherein the at least one tensioning cable is tightened to reconfigure at least one degree of freedom of the device, wherein the at least one tensioning cable constrains extension.

11. The method of claim 4, wherein the at least one tensioning cable is loosened to reconfigure at least one degree of freedom of the device, wherein the at least one tensioning cable does not provide constraint, and wherein the at least one tensioning cable allows at least one degree of freedom previously disabled.

12. The method of claim 1, wherein the method of printing is selected from a group of methods consisting of conventional 3-Dimensional printing, laser printing, sintering, Computer Numerical Control machining, and injection molding.

13. The method of claim 1, further comprising:
configuring the device in a 3-dimensional space defined by six number, wherein the device has up to five degrees of freedom and at least one degree of constraint.

14. A system for designing a multimodal and reconfigurable kinematic device, said system comprising:
a processor; and
a memory storing computer-readable instructions that, when executed by said processor, cause said processor to trigger execution of program instructions to:
model two rigid stages of the device;
assign at least one degree of freedom to at least one kinematic mode of the device;
design at least one flexural rod;
place at least one tunable flexure;
assign a thickness to the at least one flexural rod;
add mechanical details; and
modularize the device for printing.

15. The system of claim 12, wherein the at least one tunable flexure comprises a stiffness-changing rod.

16. The system of claim 12, wherein the at least one tunable flexure comprises a tensioning cable.

17. The system of claim 12, further comprising program instructions to:
optionally add at least one elastic sensing cable, wherein the at least one elastic sensing cable comprises a stretchable sensor, wherein a resistance of the stretchable sensor decreases or increases.

18. The system of claim 13, herein further comprising program instructions to:
assign a thickness to the at least one flexural rod having a diameter of 5% to 10% of a length of the at least one flexural rod.

19. A computer program product for designing a multimodal and reconfigurable kinematic device, comprising at least one non-transitory computer readable medium including program instruction that, when executed by at least one processor, cause said at least one processor to:
model two rigid stages of the device;
assign at least one degree of freedom to at least one kinematic mode of the device;
design at least one flexural rod;
place at least one tunable flexure;
assign a thickness to the at least one flexural rod;
add mechanical details; and
modularize the device for printing.

20. A wearable device designed according to the method of claim 1, wherein the at least one tunable flexure comprises at least one stiffness-changing rod.

21. A forearm joint device designed according to the method of claim 1, wherein the at least one tunable flexure comprises at least one stiffness-changing rod.

22. A wrist joint device designed according to the method of claim 1, wherein the at least one tunable flexure comprises at least one stiffness-changing rod.

23. A finger joint device designed according to the method of claim 1, wherein the at least one tunable flexure comprises at least one stiffness-changing rod.

24. A haptic thimble device designed according to the method of claim 1, wherein the at least one tunable flexure comprises at least one stiffness-changing rod.

25. A kinematic device comprising, at least two rigid stages, at least one kinematic mode, at least one flexural rod, and at least one tunable flexure, where in the device is configured to provide haptic feedback or motion control.

26. The kinematic device of claim 25, wherein the tunable flexure is a stiffness-changing rod.

27. The kinematic device of claim 26, wherein the stiffness-changing rod is heated or cooled to provide compression in at least one kinematic mode.
